(19) United States
(12) Patent Application Publication
(10) Pub. No.: US 2020/0050544 A1
(43) Pub. Date: Feb. 13, 2020

(54) INFORMATION PROCESSING APPARATUS, NON-TRANSITORY COMPUTER-READABLE RECORDING MEDIUM HAVING INFORMATION PROCESSING PROGRAM STORED THEREON, AND METHOD OF PROCESSING INFORMATION

(71) Applicant: FUJITSU LIMITED, Kawasaki-shi (JP)

(72) Inventor: Yasuhiko Uchida, Kawasaki (JP)

(73) Assignee: FUJITSU LIMITED, Kawasaki-shi (JP)

(21) Appl. No.: 16/517,749

(22) Filed: Jul. 22, 2019

(30) Foreign Application Priority Data
Aug. 8, 2018 (JP) 2018-149358

(51) Int. Cl. G06F 12/06; G06F 9/455; G06F 12/10

(52) U.S. Cl. CPC G06F 12/0646; G06F 9/45558; G06F 2212/657; G06F 2009/45583; G06F 12/10

(57) ABSTRACT

A apparatus includes a storing region and an access controller. The storing region includes: a first area to which a value indicating one of first and second bit modes is set; a second area to which information indicating whether a third bit mode is enabled or disabled is set, the first and second bit modes specifying a bit length of addresses in a memory to first and second bit lengths, respectively, the third bit mode specifying the bit length to a third bit length greater than second bit length; and an address area to which an address in the first or second bit length is set. When the information in the second area indicates that the third bit mode is enabled, the access controller accesses the memory based on a concatenated address defined by concatenating the value set in the first area and the address set in the address area.

### CROSS-REFERENCE TO RELATED APPLICATION

This application is based upon and claims the benefit of priority of the prior Japanese Patent Application No. 2018-149358, filed on Aug. 8, 2018, the entire contents of which are incorporated herein by reference.

### FIELD

The present disclosure relates to an information processing apparatus, a non-transitory computer-readable recording medium having an information processing program stored thereon, and a method of processing information.

### BACKGROUND

An operating system (OS) of an information processing apparatus, such as an OS of a host computer (e.g., a mainframe), which performs virtual storage addressing to virtual storage areas, may support multiple addressing modes, including 24-bit and 31-bit modes.

A virtual storage area is a virtual address space in a memory (primary storage) specified by a virtual address. Virtual addresses are translated to real addresses by means of an address translation, known as the dynamic address translation (DAT). For example, virtual addresses employed by an OS as described above occupy address spaces of 24- and 31-bit long, and the maximum available area sizes for 24- and 31-bit virtual addresses are 16 megabytes (MB) and 2 gigabytes (GB), respectively. Kernels and programs on the OS can reserve virtual storage areas that are independent from each other.

Therefore, the OS that executes programs, including kernels and applications, can use virtual storage areas (address spaces) of 16 MB at maximum in the 24-bit mode and 2 GB at maximum in the 31-bit mode.

Patent Literature 1: Japanese Laid-open Patent Publication No. 01-147747

Patent Literature 2: Japanese Laid-open Patent Publication No. 63-113635

In the architectures of OSs used in mainframes and the like, the maximum lengths of virtual addresses are limited to 31 bits, for example, in which case the maximum available capacity of the address space is merely 2 GB. However, in some OSs (e.g., OSs from overseas vendors), the used memory capacity tends to increase, and a 2-GB address space reserved by a kernel may become deficient.

It is considered that such a deficiency of address spaces can be compensated for by adding a new address space, or by adopting a 64-bit architecture, for example.

However, when anew address space is reserved, switching may arise between the existing address spaces and the new address space, and an overhead may be experienced in this case, which may lead to a reduced performance of the processor, such as a central processing unit (CPU).

In addition, when a 64-bit architecture is adopted, significant modifications and additions of resources are demanded to the 24 and/or (hereinafter, slash (/) is used to denote “and/or”) 31-bit architectures, as well as to an OS and hardware (HW), which may incur an increase in development costs. In addition, there is a possibility that a part of functions operating on the existing 24/31-bit architectures might not work on the 64-bit architecture.

### SUMMARY

According to an aspect of the embodiments, an information processing apparatus may include a memory, and a processor coupled to the memory. The processor may include a first storing region and an access controller. The first storing region may include a first setting area, a second setting area, and an address area. To the first setting area, a value indicating either one of a first bit mode and a second bit mode is set, the first bit mode specifying a bit length of addresses in the memory to a first bit length, the second bit mode specifying the bit length to a second bit length greater than the first bit length, may be set. To the second setting area, information indicating whether a third bit mode is enabled or disabled is set, the third bit mode specifying the bit length to a third bit length greater than the second bit length, may be set. To the address area, an address in the first bit length or the second bit length may be set. The access controller may be configured to, when the information set in the second setting area indicates that the third bit mode is enabled, access the memory based on a concatenated address defined by concatenating the value set in the first setting area and the address set in the address area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an exemplary hardware configuration of a computer system in accordance with one embodiment;

FIG. 2 is a block diagram illustrating an exemplary configuration of a CPU in accordance with one embodiment;

FIG. 3 is a block diagram illustrating an exemplary configuration of a memory in accordance with one embodiment;

FIG. 4 is a flow chart illustrating exemplary operations of an instruction execution process by a CPU;

FIG. 5 is a diagram illustrating examples of address spaces;

FIG. 6 is a diagram illustrating one example of an instruction address and an operand address;

FIG. 7 is a diagram illustrating one example of a program state word (PSW) format;

FIG. 8A is a diagram illustrating an exemplary setting for a 24-bit mode;

FIG. 8B is a diagram illustrating an exemplary setting for a 31-bit mode;

FIG. 8C is a diagram illustrating an exemplary setting for a 32-bit mode;

FIG. 9 is a diagram for describing address spaces;

FIG. 10 is a flowchart illustrating exemplary operations of an address space determination process;

FIG. 11 is a flowchart illustrating exemplary operations of a PSW format check process;

FIG. 12 is a flowchart illustrating exemplary operations of an instruction address space determination process;

FIG. 13 is a flowchart illustrating exemplary operations of an operand address space determination process;

FIG. 14 is a diagram illustrating examples of 24/31/32-bit virtual address formats;

FIG. 15 is a diagram illustrating one example of a segment table descriptor (STD) format supporting 32 bits;

FIG. 16 is a diagram illustrating an example of comparisons among segment table length (STL) bit widths;

FIG. 17 is a diagram for describing registers used for an STD;

FIG. 18 is a diagram illustrating examples of a segment table entry (STE) and a page table entry (PTE);

FIGS. 19A and 19B are diagrams each illustrating one example of a 40-bit real address;

FIG. 20 is a diagram illustrating one example of a dynamic address translation supporting 32 bits;

FIG. 21 is a diagram illustrating exemplary calculations of maximum entry counts in address translation tables;

FIG. 22 is a diagram illustrating an exemplary setting of support information;

FIG. 23 is a block diagram illustrating an exemplary functional configuration of a computer system in accordance with one embodiment;

FIG. 24 is a diagram illustrating exemplary settings for software;

FIG. 25 is a diagram illustrating an example of switching between address spaces;

FIG. 26 is a diagram illustrating one example of the PROGRAM CALL (PC) instruction;

FIG. 27 is a diagram illustrating one example of an operation of the PC instruction;

FIG. 28 is a diagram illustrating one example of the Entry-Table entry (the PC instruction);

FIGS. 29A and 29B are diagrams each illustrating an example of an operation pattern of the PC instruction;

FIG. 30 is a diagram illustrating one example of the BRANCH AND STACK (BAKR) instruction;

FIG. 31 is a diagram illustrating one example of an operation of the BAKR instruction;

FIG. 32 is a diagram illustrating one example of the first operand of the BAKR instruction;

FIGS. 33A-33C are diagrams each illustrating one example of the second operand of the BAKR instruction;

FIG. 34 is a diagram illustrating one example of the PROGRAM TRANSFER (PT) instruction;

FIG. 35 is a diagram illustrating one example of an operation of the PT instruction;

FIG. 36 is a diagram illustrating one example of the operand formats of the PT instruction;

FIG. 37 is a diagram illustrating one example of the PROGRAM RETURN (PR) instruction;

FIG. 38 is a diagram illustrating one example of an operation of the PR instruction;

FIG. 39 is a diagram illustrating an example of modifications to general instructions for supporting 32 bits;

FIG. 40 is a diagram illustrating an example of modifications to control instructions for supporting 32 bits;

FIG. 41 is a block diagram illustrating an exemplary configuration of a channel subsystem in accordance with one embodiment;

FIG. 42 is a flowchart illustrating exemplary operations of an instruction execution process by the channel subsystem;

FIG. 43 is a diagram illustrating one example of memory references by the input-output (I/O) start instruction;

FIG. 44 is a diagram illustrating one example of an operation request block (ORB) format;

FIG. 45 is a diagram illustrating one example of a channel command words (CCW) format;

FIG. 46 is a diagram for describing data address spaces;

FIG. 47 is a flowchart illustrating exemplary operations of an address space determination process;

FIG. 48 is a flowchart illustrating exemplary operations of an ORB format check process;

FIG. 49 is a flowchart illustrating exemplary operations of a CCW address space determination process;

FIG. 50 is a flowchart illustrating exemplary operations of a data address space determination process;

FIG. 51 is a diagram illustrating one example of the STD0/STD1 (ORB) format supporting 32 bits; and

FIG. 52 is a diagram illustrating one example of a channel dynamic address translation supporting 32 bits.

### DESCRIPTION OF EMBODIMENTS

Hereinafter, embodiments of the present disclosure will be described with reference to the drawings. Note that the embodiments described below are merely exemplary, and it is not intended to exclude a wide variety of modifications to and applications of techniques that are not described explicitly in the following. For example, the present disclosure may be practiced in various modifications without departing from the spirit thereof. Note that elements referenced to by the same reference symbols in the drawings mentioned in the following descriptions denote the same or similar elements, unless otherwise stated.

<<1>> One Embodiment

As set forth above, in architectures of OSs used in mainframes and the like, a 2-GB address space reserved by a kernel may become deficient.

A deficiency of address spaces in general OSs is expected to amount to, for example, 0.3 GB (about 15%). If an additional address space is created to compensate for the deficiency of about 15%, frequent switching between address spaces may occur, which may cause an overhead, resulting in a reduced performance of the processor.

Or, if a 64-bit architecture is adopted, necessary HW resources for program state words (PSWs) and various registers are doubled. The number of instructions is also doubled for supporting two types of registers, which may demand significant modifications of HW.

Furthermore, because drastic modifications to formats of control registers and control information make continued use of existing formats difficult, significant modifications are to be made on both the OS and HW. In addition, the recent shortage of engineers may render significant modifications (developments) per se difficult in some cases.

Additionally, some OSs provided by Japanese vendors and user applications used in mainframes and the like have not experienced any memory deficiencies up to now. However, if a 64-bit architecture is adopted, there may be a risk where a part of functions operated on 24/31 bits may not work in those OSs provided by Japanese vendors and user applications, which may demand 64-bit supports.

In view of the above-identified issues, in one embodiment, as one viewpoint, a technique to extend memory areas, e.g., virtual address spaces, used by OSs and user applications to 2 GB or more, will be described. Note that this technique intends to compensate for a deficient capacity of about 15%, as described above, and thus a significant extension of the capacity is not intended.

Further, as another viewpoint, because an additional address space may cause an overhead due to switching between address spaces, a technique to extend a single virtual address area will be described in one embodiment.

Furthermore, as another viewpoint, descriptions will be made on a technique to extend virtual address areas by utilizing existing unused resources (bits) and the like, without incurring a significant increase in HW resources as in cases in which a 64-bit architecture is adopted, for example. For example, in one embodiment, no additional HW resources are provide for PSWs and registers, or no new instructions are provided.

Furthermore, as another viewpoint, descriptions will be made on a technique to permit the conventional functions (e.g., in 24/31 bits) to continue to operate without recompiling, in OSs and user applications (e.g., those operating on 24/31 bits) which demands no extension of a memory.

<<1-1>> Exemplary Configuration

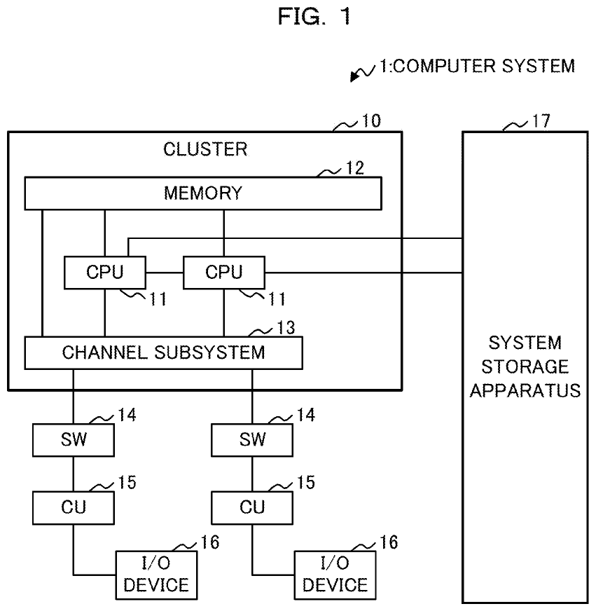

Hereinafter, referring to FIG. 1, an exemplary hardware configuration of a computer system 1 in accordance with one embodiment will be described. The computer system is one example of a host computer (information processing apparatus) that performs virtual storage addressing to virtual storage areas.

As illustrated in FIG. 1, the computer system 1 may include multiple (two in the example in FIG. 1) CPUs 11, a memory 12, a channel subsystem 13, and a system storage apparatus 17, as an example. The computer system 1 may also include multiple (two in the example in FIG. 1) sets of a switch (SW) 14, a control unit (CU) 15, and an input-output (I/O) device 16, as an example.

Each CPU 11 is coupled to the memory 12, and is one example of a computation processing apparatus or processor that performs a wide variety of controls and computations. Each CPU 11 may be coupled to blocks in the computer system 1 via a bus so as to communicate with each other.

Examples of the CPUs 11 may include integrated circuits (ICs), such as MPUs, DSPs, ASICs, and FPGAs, for example. MPU is an abbreviation of Micro Processing Unit, and DSP is an abbreviation of Digital Signal Processor. ASIC is an abbreviation of Application Specific IC, and FPGA is an abbreviation of Field-Programmable Gate Array.

The memory 12 is hardware that can store information, such as a wide variety of data and programs, and is one example of a primary storage. As illustrated in FIG. 1, the memory 12 may be coupled to each of the multiple CPUs 11, thereby providing each CPU 11 with a shared storage area. Examples of the memory 12 include volatile memories, such as dynamic random access memories (DRAMs), e.g., dual inline memory modules (DIMMs), for example.

Each CPU 11 realizes functions of an OS, applications, and the like by executing kernels and programs (not illustrated) stored in the memory 12 or other storages.

The channel subsystem 13 is coupled (directly or indirectly) to the memory 12 and to the I/O devices 16, and is one example of a processor or input-output processor that controls communications of various types of information, such as data and control signals, between the memory 12 and peripheral devices including the I/O devices 16. Integrated circuits (ICs), such as MPUs, DSPs, ASICs, and FPGAs, may be used as the channel subsystem 13, for example.

The CPUs 11, the memory 12, and the channel subsystem 13 may configure one or more cluster 10. In the cluster 10, the multiple CPUs 11 may execute parallel processes.

Each SW 14 connects the channel subsystem 13, i.e., the cluster 10, to peripheral devices (e.g., the I/O device 16) such that they communicate with each other. Each CU 15 is a controller that controls the peripheral devices (e.g., the I/O device 16).

Each I/O device 16 is one example of a peripheral device coupled to the cluster 10, for example, and may be any of a wide variety of devices, such as a storage device, a communication device, and a monitoring device. Each I/O device 16 may be able to mutually communicate with the CPUs 11 and the memory 12 via the CU 15, the SW 14, and the channel subsystem 13.

Note that examples of a storage device include a wide variety of devices, such as magnetic disk devices, e.g., hard disk drives (HDDs), semiconductor drive devices, e.g., solid state drives (SSDs), and non-volatile memories, for example. Examples of non-volatile memories include flash memories, storage class memories (SCMs), and read only memories (ROMs), for example.

The system storage apparatus 17 realizes fast data transfers between the CPUs 11 and the like in the cluster 10, and may carry out controls for efficient parallel processing by the CPUs 11 in the cluster 10.

Note that the above-described hardware configuration of the computer system 1 is merely exemplary. Accordingly, hardware may be added or omitted in the computer system 1 (e.g., any blocks may be added or omitted), divided, or combined in any combinations, or a bus may be added or omitted, where it is deemed appropriate. For example, the computer system 1 may be provided with a network interface (IF) or other hardware such that a wide variety of information, such as data and programs, may be received from and sent to an unillustrated network.

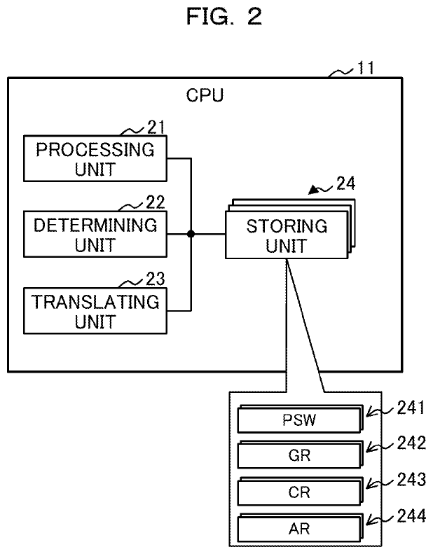

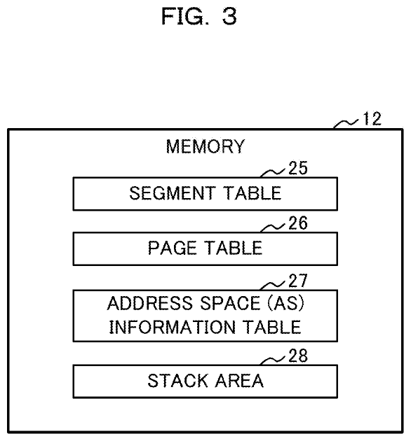

Next, referring to FIGS. 2 and 3, examples of configurations of the CPUs 11 and the memory 12 in accordance with one embodiment will be described. As illustrated in FIG. 2, in the computer system 1, each CPU 11 may include a processing unit 21, a determining unit 22, a translating unit 23, and multiple storing units 24, as an example.

The processing unit 21 executes the OS and applications by executing a wide variety of processing by reading and executing instructions in kernels and programs. In one embodiment, the processing unit 21 makes the 32-bit mode (having a virtual storage space of 4 GB) enhancingly available for addressing to virtual storage areas, in addition to the 24-bit and 31-bit modes that are available conventionally. In other words, the CPUs 11 can support an OS and applications operating in the 32-bit mode, in addition to supporting an OS and applications operating in the 24-bit or 31-bit mode.

The determining unit 22 determines the type of address spaces of instruction addresses and operand addresses. For example, the determining unit 22 may make determinations on 24-bit, 31-bit, and 32-bit address spaces.

The translating unit 23 performs a translation of an instruction address or an operand address in accordance with the address space determined by the determining unit 22. The processing unit 21 may execute processing in accordance with the address translated by the translating unit 23.

Note that, for example, the processing unit 21, the determining unit 22, the translating unit 23, and the multiple storing units 24 may be embodied by hardware, such as a processing circuit, a determining circuit, a translating circuit, and multiple registers, respectively. Hereinafter, “circuit” may be read as “controller”. The translating unit 23 as the translating circuit may be a circuit having a dynamic address translation (DAT), for example. The multiple storing units 24 as registers may include a wide variety of registers, such as a PSW 241, multiple GRs 242, multiple CRs 243, and multiple ARs 244, which will be described later, for example. Note that GR is an abbreviation of General Register, CR is an abbreviation of Control Register, and AR is an abbreviation of Access Register.

Furthermore, as illustrated in FIG. 3, in the computer system 1, the memory 12 may store information, such as a segment table 25, a page table 26, and an address space (AS) information table 27, as an example. The memory 12 may further include a stack area 28 as a storage area. Although the tables 25 to 27 will be described as information having tabular formats in the following description for the sake of convenience, the tables 25 to 27 may be information stored in any other formats, such as arrays and databases (DBs).

Details of the CPU 11 and the memory 12 will be described later.

<<1-2>> Processing by CPUs

Next, processing by the CPUs 11 will be described.

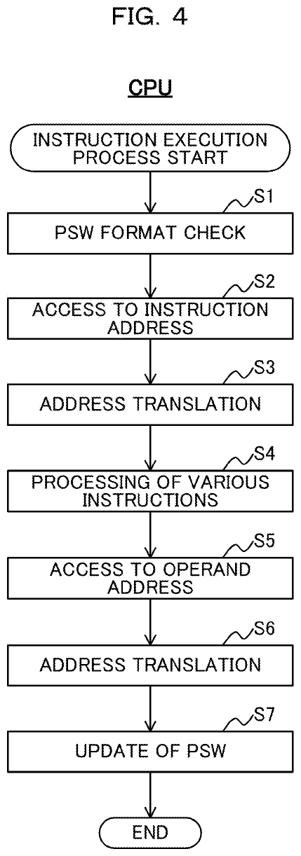

Initially, referring to FIG. 4, exemplary operations of an instruction execution process by a CPU 11 will be described. Each CPU 11 is provided with a PSW 241 (refer to FIG. 2), and the CPU 11 executes an instruction one by one in accordance with the content in the PSW 241. The PSW 241 is one example of a storing circuit (unit) or first storing circuit (unit), or a storing region or a first storing region configured to store the current status of the CPU 11, the address on the memory 12 of an instruction that is to be executed the next, and the like. FIG. 4 illustrates the procedure to execute a single instruction by a CPU 11.

The determining unit 22 in the CPU 11 checks the format of the PSW 241 (Step S1), and determines the type of an address space of an instruction address. The processing unit 21 in the CPU 11 accesses the instruction address (Step S2). The translating unit 23 in the CPU 11 performs an address translation (Step S3). The processing unit 21 then processes various instructions (Step S4).

In addition, the determining unit 22 determines the type of an address space of an operand address, and the processing unit 21 accesses the operand address (Step S5). The translating unit 23 performs an address translation (Step S6). The processing unit 21 updates the PSW 241 (Step S7), and the process to execute the single instruction ends.

(Descriptions on Address Translation)

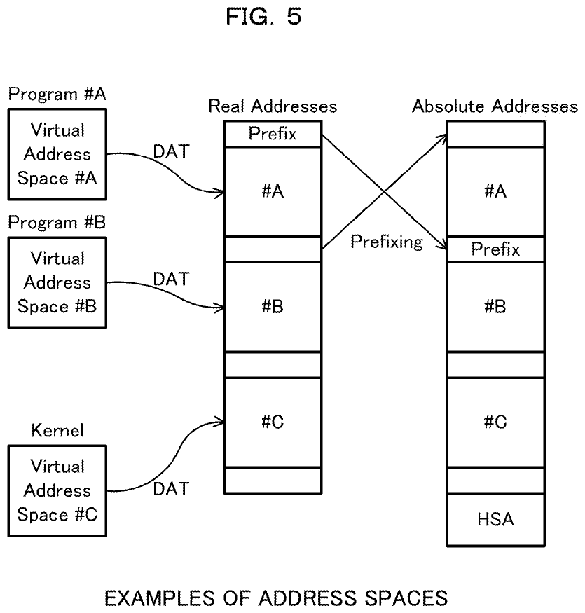

Here, address translations in Steps S3 and S6 will be described. FIG. 5 is a diagram illustrating examples of address spaces in the memory 12.

The memory 12 has three types of addresses as address spaces: virtual addresses, real addresses, and absolute addresses.

Virtual addresses have multiple modes, including PRIMARY, SECONDARY, HOME, and AR. Virtual addresses are translated to real addresses by means of an address translation (e.g., DAT) by the translating unit 23 (refer to “DATs” in FIG. 5). The virtual address spaces # A to # C illustrated in FIG. 5 that are used by Programs # A and # B and a kernel are translated to real address spaces # A to # C, respectively.

Real addresses are used when users access the memory 12 without making any translations. A real address is translated to an absolute address by means of swapping (called prefixing) between a prefix (Addresses 0-4096) area and an address area specified by a prefix register (refer to “Prefixing” in FIG. 5) Real addresses have 24-, 31-, and 40-bit address spaces, the maximum available area sizes of which are 16 MB, 2 GB, and 1 TB, respectively.

Absolute addresses are addresses assigned to respective storage locations in the memory 12, and are primarily used when hardware accesses the memory 12. The area of absolute addresses has a size determined depending on the total capacity of DIMMs installed in the system, and includes a hardware system area (HSA; refer to FIG. 5) where accesses by users are restricted (area set to be inaccessible). Note that real addresses includes no HSA.

Although Steps S3 and S6 in FIG. 4 indicate translations (DATs) from virtual addresses to real addresses by the translating unit 23 illustrated in FIG. 5, additional prefixing may be performed when the CPU 11 accesses the memory 12.

(Descriptions on Accesses to Instruction Address and Operand Address)

Next, accesses to an instruction address and an operand address by the processing unit 21 and the determining unit 22 will be described.

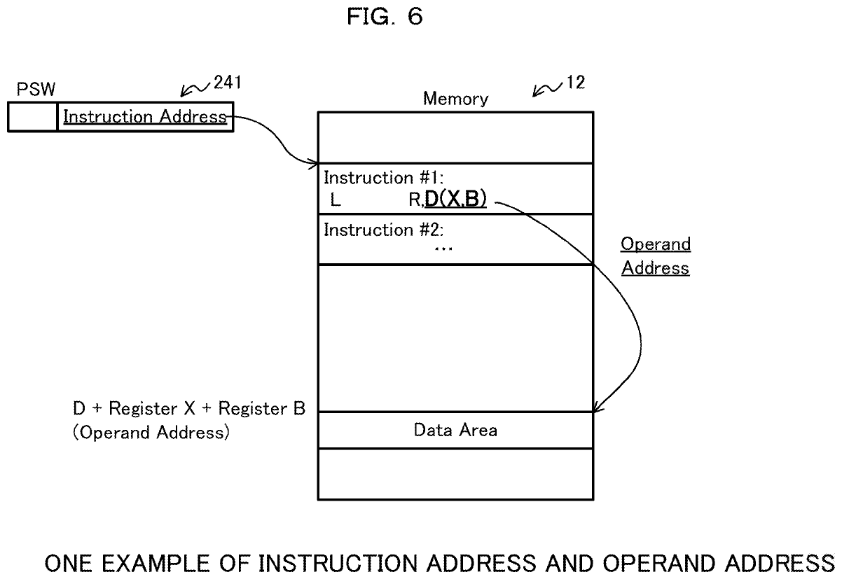

As exemplified in FIG. 6, a CPU 11 reads an instruction stored in the storage area in the memory 12, which is specified by an instruction address in the PSW 241, and executes the instruction that is read (corresponding to Steps S1 to S4 in FIG. 4) Each CPU 11 is provided with the storing units 24, e.g., registers, and some instructions may have an operand address specified by means of a register. In this case, the CPU 11 may read or write data from or to the location of the operand address (corresponding to Step S5 in FIG. 4). Once the execution of the instruction completes, the CPU 11 updates the instruction address in the PSW 241 (corresponding to Steps S6 to S7 in FIG. 4) and moves to the next instruction.

Note that the type of address spaces of an instruction address and an operand address is determined in accordance with setting information in the PSW 241.

Next, details of the processing by a CPU 11 will be described, with reference to the procedure to perform the instruction execution process illustrated in FIG. 4.

<<1-2-1>> PSW Format Check

(Descriptions on PSW Format)

A PSW 241 has a 64-bit data format, for example, and a single PSW 241 may be provided for one CPU 11. A PSW 241 may store CPU information used for operations of programs, such as address spaces and an instruction address.

Here, the PSW 241 in accordance with one embodiment may be provided with AX bit that is a bit used to enable or disable the 32-bit virtual address mode. A CPU 11 may control 32-bit virtual addressing in accordance with the value of AX bit, thereby the 32-bit virtual address mode is added to address spaces of an instruction address in the PSW 241 and an operand addresses of each instruction.

AX bit may be Bit 30 (AX), for example. Note that, because Bit 30 is an area to which a value of 0 is set prior to the modifications of the present disclosure (prior to the definitions of the present disclosure), the conventional functions are not affected by the addition of Bit 30 (AX).

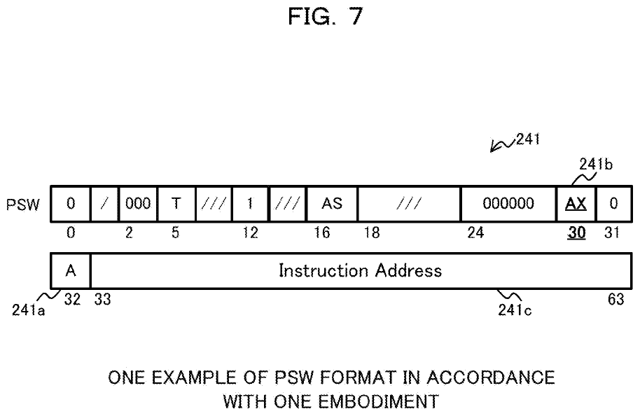

FIG. 7 is a diagram illustrating one example of the format of the PSW 241 in accordance with one embodiment. Hereinafter, each of bits or bit ranges in the PSW 241 will be described.

<Bits 0, 2-4, 24-29, and 31>

To these bits, values of 0 are set. When a value other than 0 is set to any of these bits, the determining unit 22 reports an exception as a format error of the PSW 241. Note that examples of exception reports include logging of error logs and the like, and notifications to administrators and other uses. Similar exception reports are made in the following descriptions.

<Bit 5 (T)>

Bit 5 (T) specifies the address space information of an instruction address or an operand address. When Bit 5 (T) has a value of 1, the address space contains a virtual address. When Bit 5 (T) has a value of 0, the address space contains a real address. In other words, Bit 5 (T) is used to specify the address space to be either one of a real address and a virtual address.

<Bit 12>

A value of 1 is set to Bit 12. When a value other than 1 is set to Bit 12, the determining unit 22 reports an exception as a format error of the PSW 241.

<Bits 16-17 (AS)>

Bits 16-17 (AS) specify one of the space modes of PRIMARY, SECONDARY, AR, and HOME when the address space is a virtual address.

<Bit 30 (AX)>

It is a bit indicating whether the 32-bit virtual address mode is enabled or not. When Bit 30 (AX) has a value of 1, the instruction address or the operand address functions in the 32-bit mode. Otherwise, when Bit 30 (AX) has a value of 0, the addresses functions in the 24/31-bit mode in the same manner as the conventional techniques, depending on the value of Bit 32 (A)

Setting of Bit 30 (AX) may be restricted such that it can be set to a value of 1 only when Bit 5 (T) has a value of 1 (when virtual addresses are enabled). In this manner, it can be regarded that Bit 30 (AX) specifies the address space to be 32-bit long when it has a value of 1, and further specifies the address space to be 31/24-bit long by making a reference to Bit 32 (A) when it has a value of 0. Note that, if a value of 1 is set to Bit 30 (AX) when Bit 5 (T) has a value of 0 (a virtual address is disabled=real addresses), the determining unit 22 reports an exception as a format error of the PSW 241.

The storage area 241b (refer to FIG. 7) assigned as Bit 30 (AX) is one example of a second setting area to which information indicating whether a third bit mode is enabled or disabled is set. The third bit mode is a bit mode that specifies a bit length of addresses in the memory 12 to a third bit length (e.g., 32 bits) that is greater than a second bit length (e.g., 31 bits).

<Bit 32 (A)>

The processing for Bit 32 (A) varies depending on the value of Bit 30 (AX). For example, Bit 32 (A) may be processed depending on the value of Bit 30 (AX) as follows.
When Bit 30 (AX) has a value of 1

Bit 32 (A) is processed as the most significant bit (Bit 0) of an instruction address. In other words, 32 bits of Bits 32-63 are used as an instruction address.
When Bit 30 (AX) has a value of 0

Bit 32 (A) is used to determine whether the mode is the 24- or 31-bit mode in the same manner as the conventional techniques. In other words, in this case Bit 32 (A) specifies the address space information of an instruction address or an operand address. When Bit 32 (A) has a value of 1, the address space contains a 31-bit address. When Bit 32 (A) has a value of 0, the address space contains a 24-bit address.

The storage area 241a (refer to FIG. 7) assigned as Bit 32 (A) is a one example of a first setting area to which a value indicating either one of a first bit mode and a second bit mode is set. The first bit mode is a bit mode that specifies a bit length of addresses in the memory 12 to a first bit length (e.g., 24 bits). On the other hand, the second bit mode is a bit mode that specifies the bit length to a second bit length (e.g., 31 bits) that is greater than the first bit length.

<Bits 33-63 (Instruction Address)>

To Bits 33-63 together with Bit 32 (A), a 32-bit address at maximum can be specified. Bits 33 (32)-63 specify the address in the memory 12 which stores a CPU instruction that is currently being executed.

When in the 24-bit mode, 24 bits of Bits 40-63 in Bits 33-63 are used as an instruction address, and values of 0 are set to Bits 33-39. Note that, when a value other than 0 is set to Bits 33-39, the determining unit 22 reports an exception as a format error of the PSW 241.

When in the 31-bit mode, 31 bits of Bits 33-63 are used as an instruction address.

When in the 32-bit mode, 32 bits of Bits 32-63 including Bit 32 (A) are used as an instruction address.

The storage area 241c (refer to FIG. 7) assigned as Bits 33-63 (instruction address) is one example of an address area to which an address in the first bit length or the second bit length is set. In addition, the address indicated by the extended Bits 32-63 is one example of a concatenated address (virtual address) defined by concatenating the value set in the first setting area and the address set in the address area, when information set in the second setting area indicates that the third bit mode is enabled.

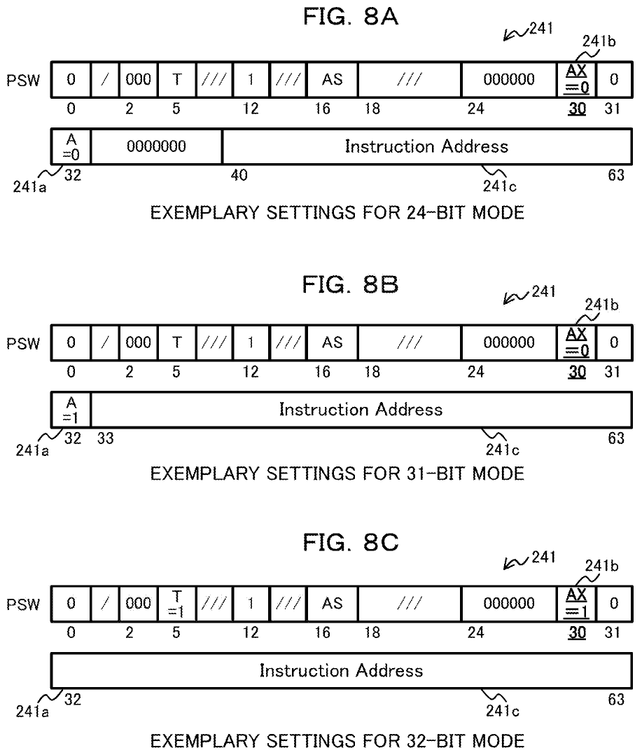

As described above, the determining unit 22 determines that the address space is in the 24-bit mode when Bit 30 (AX)=0 and Bit 32 (A)=0 as illustrated in FIG. 8A. Or, the determining unit 22 determines that the address space is in the 31-bit mode when Bit 30 (AX)=0 and Bit 32 (A)=1, as illustrated in FIG. 8B. Note that a virtual address or a real address is determined in accordance with Bit 5 (T), and in case of a virtual address, the space mode is determined in accordance with Bits 16-17 (AS).

In addition, the determining unit 22 determines that the address space is in the 32-bit mode (virtual address) when Bit 30 (AX)=1 and Bit 5 (T)=1 (a virtual address is disabled), as illustrated in FIG. 8C. Note that the space mode is determined in accordance with Bits 16-17 (AS).

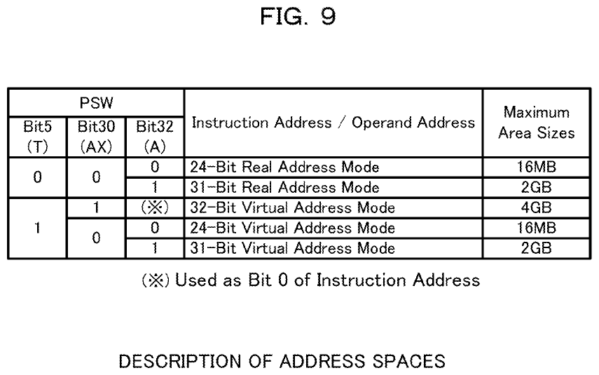

In summary, an address space of an instruction address or an operand address can be identified (determined) from setting information in the PSW 241, e.g., Bit 5 (T), Bit 30 (AX), and Bit 32 (A), as illustrated in FIG. 9.

Furthermore, the processing unit 21 and the determining unit 22 are examples of an access circuit (unit) or an access controller configured to access the memory 12 based on a concatenated address defined by concatenating the value set in Bit 32 (A) and an address set in Bits 33-63 when the 32-bit mode is enabled.

(Exemplary Operations of Determination Process of Address Space)

Next, exemplary operations of a determination process of an address space by the determining unit 22 will be described. For example, the determining unit 22 may determine the types of address spaces during a PSW format check indicated in Step S1, and prior to accesses to an instruction address/operand address indicated in Steps S2 and S5, in FIG. 4.

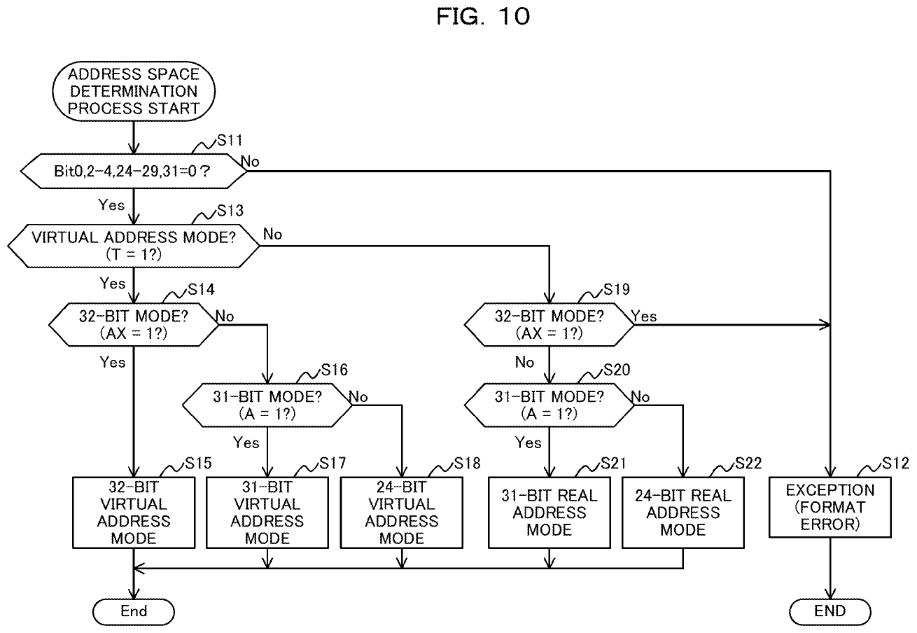

FIG. 10 is a flowchart illustrating exemplary operations of an address space determination process. As illustrated in FIG. 10, the determining unit 22 checks the bits that are defined to have a value of 0 (Step S11). If a value other than 0 is set to any of these bits (No from Step S11), the determining unit 22 reports an exception as a format error of the PSW 241 (Step S12) and the process ends. Note that, in one embodiment, Bit 30 assigned as AX bit is excluded from the 0 value check in Step S11, as illustrated in FIG. 10.

If all of the bits that are defined to have a value of 0 are set to a value of 0 (Yes from Step S11), the determining unit 22 checks Bit 5 (T) to determine whether or not the virtual address mode is enabled (T=1) (Step S13). If the virtual address mode is enabled (Yes from Step S13), the determining unit 22 checks Bit 30 (AX) to determine whether or not the 32-bit mode is enabled (Step S14).

If the 32-bit mode is enabled (Yes from Step S14), the determining unit 22 determines as the 32-bit virtual address mode (Step S15) and the process ends. In this case, Bit 32 (A) is processed as a part of an instruction address.

If the 32-bit mode is not enabled (AX=0) (No from Step S14), the determining unit 22 checks Bit 32 (A) to determine whether or not the 31-bit mode is enabled (A=1) (Step S16).

If the 31-bit mode is enabled (Yes from Step S16), the determining unit 22 determines as the 31-bit virtual address mode (Step S17) and the process ends.

If the 31-bit mode is not enabled (A=0) (No from Step S16), the determining unit 22 determines as the 24-bit virtual address mode (Step S18) and the process ends.

Otherwise, if in the real address mode (T=0) in Step S13 (No from Step S13), the determining unit 22 checks Bit 30 (AX) to determine whether or not the 32-bit mode is enabled (AX=1) (Step S19).

If the 32-bit mode is enabled (Yes from Step S19), the determining unit 22 reports an exception as a format error of the PSW 241 (Step S12) and the process ends. This is because the restriction (definition) that Bit 30 (AX) shall have a value of 0 in the real address mode is violated.

If the 32-bit mode is not enabled (AX=0) (No from Step S19), the determining unit 22 checks Bit 32 (A) to determine whether or not the 31-bit mode is enabled (A=1) (Step S20).

If the 31-bit mode is enabled (Yes from Step S20), the determining unit 22 determines as the 31-bit real address mode (Step S21) and the process ends.

If the 31-bit mode is not enabled (A=0) (No from Step S20), the determining unit 22 determines as the 24-bit real address mode (Step S22) and the process ends.

(Example of More Detailed or Alternative Operations of Determination Process of Address Space)

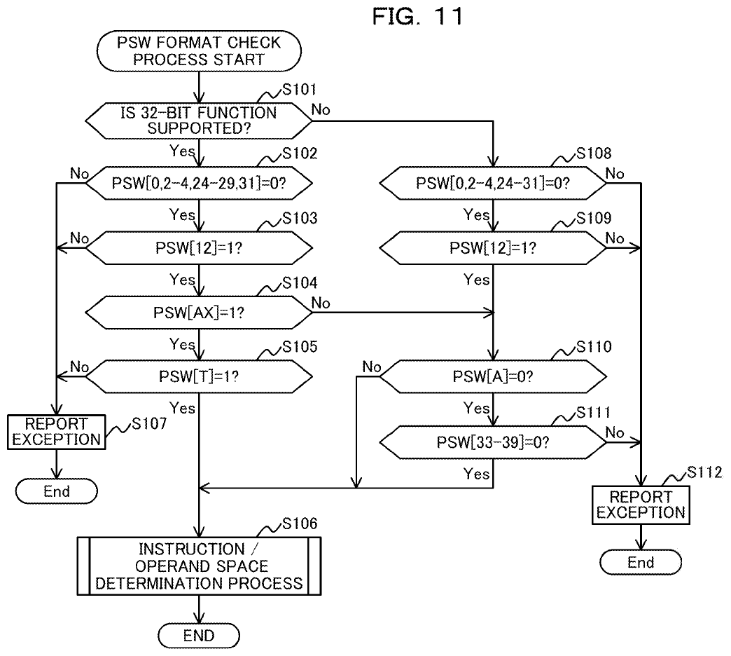

Next, an example of more detailed or alternative operations of the determination process of an address space will be described. FIGS. 11 to 13 are flowcharts illustrating exemplary operations of the PSW format check process, the instruction address space determination process, and the operand address space determination process, respectively.

A PSW format check by the determining unit 22 may be modified in accordance with the modification to the format of PSWs 241 for the 32-bit function (refer to FIG. 7) as follows.

As exemplified in FIG. 11, after the determining unit 22 checks the support information of the 32-bit virtual address function (Step S101), the process may branch to the conventional PSW format check, or to the PSW format check for the 32-bit function, depending on the result of the check.

When the 32-bit virtual address function is supported (Yes from Step S101), the determining unit 22 may execute Steps S102 to S107 as the PSW format check for the 32-bit function. Note that Steps S102, S104, and S105 are similar to Steps S11, S14, and S13 in FIG. 10, respectively.

In Step S103, the determining unit 22 determines whether or not 1 is set in Bit 12. If the determination is No from any of Steps S102, S103, and S105, the determining unit 22 reports an exception of the PSW format (Step S107) and the process ends. If the determination is No from Step S104, the process transitions to Step S110. Otherwise, if the determinations are Yes in all of Steps S101 to S105, the determining unit 22 executes a determination process of an instruction and/or operand space (Step S106) and the process ends.

If the 32-bit virtual address function is not supported (No from Step S101), the determining unit 22 may execute Steps S108 to S112 as the conventional PSW format check.

The determining unit 22 checks the bits that are defined to have a value of 0, including Bit 30 (AX) (Step S108). If all of these bits have a value of 0 (Yes from Step S108), the determining unit 22 determines whether or not Bit 12 has a value of 1 (Step S109).

If Bit 12 has a value of 1 (Yes from Step S109), the determining unit 22 determines whether or not Bit 32 (A) has a value of 0 (Step S110). If A=1 (No from Step S110), the processing transitions to Step S106.

If A=0 (Yes from Step S110), the determining unit 22 determines whether or not all of Bits 33-39 have a value of 0 (Step S111). If all of Bits 33-39 have a value of 0 (Yes from Step S111), the process transitions to Step S106.

If the determination is No from any of Steps S108, S109, and S111, the determining unit 22 reports an exception of the PSW format (Step S112) and the process ends.

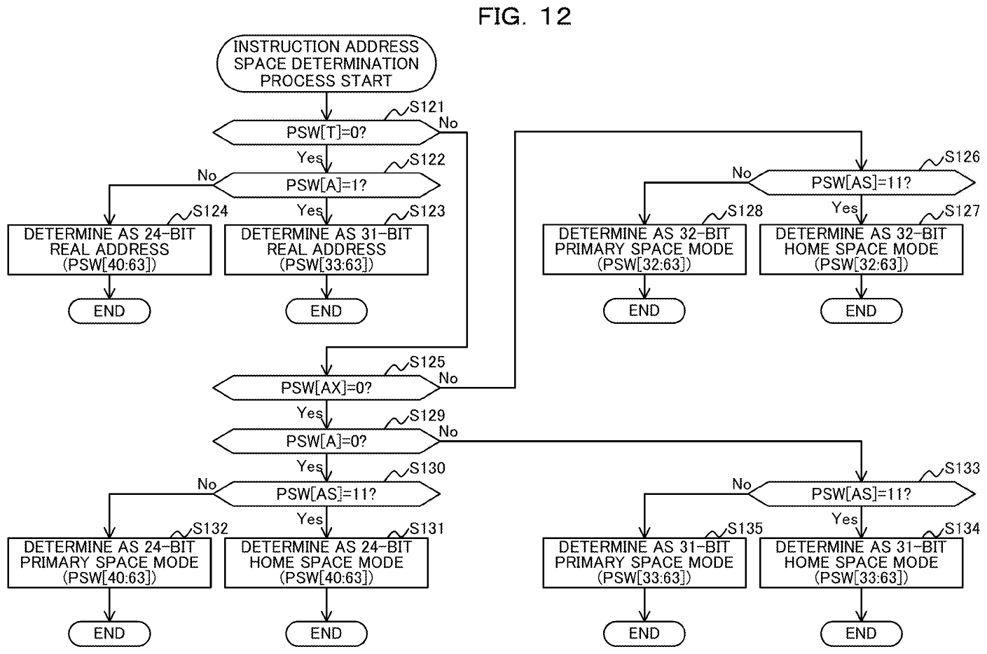

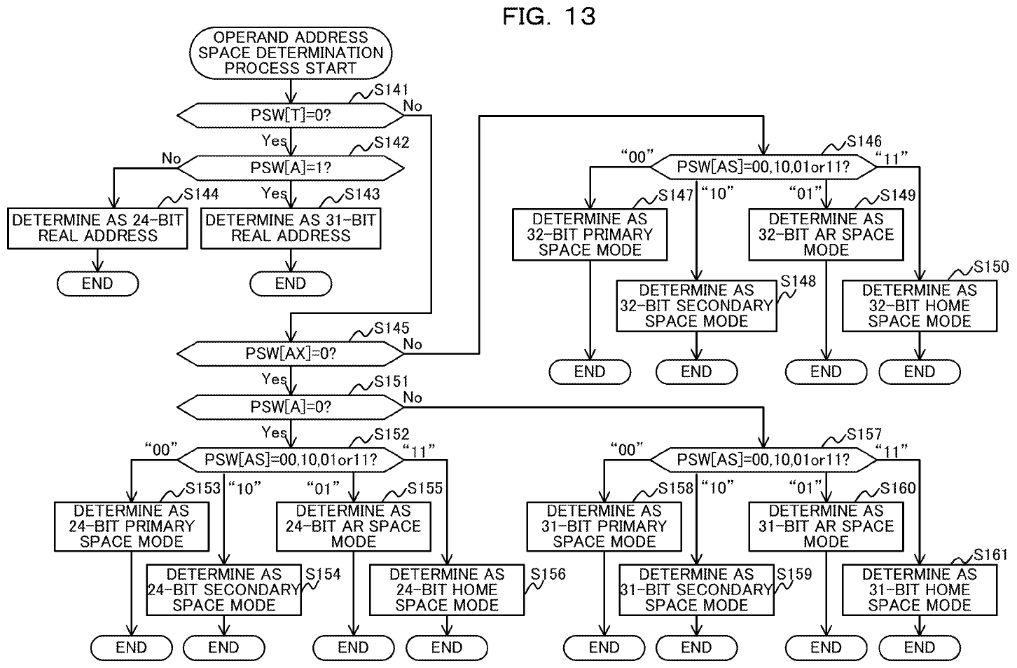

Next, an address space determination process for an instruction address (FIG. 12) and an address space determination process for an operand address (FIG. 13), depicted in Step S106, will be described.

<Address Space Determination Process for Instruction Address>

Virtual address spaces take either one of the PRIMARY space mode and the HOME space mode. Therefore, instruction address spaces take either one of the 24-bit real address mode, the 31-bit real address mode, the 24-bit PRIMARY space mode, the 31-bit PRIMARY space mode, the 24-bit HOME space mode, and the 31-bit HOME space mode.

In addition to these, in one embodiment, the 32-bit PRIMARY space mode and the 32-bit HOME space mode are added to instruction address spaces by the support of the 32-bit virtual address function.

As exemplified in FIG. 12, the determining unit 22 determines whether or not Bit 5 (T) in the PSW 241 has a value of 0 (Step S121). If T=0 (real address) (Yes from Step S121), the determining unit 22 determines whether or not Bit 32 (A) has a value of 1 (Step S122).

If A=1 (Yes from Step S122), the determining unit 22 determines that the address is a 31-bit real address (i.e., an instruction address is contained in Bits 33-63) (Step S123) and the process ends.

If A=0 (No from Step S122), the determining unit 22 determines that the address is a 24-bit real address (i.e., an instruction address is contained in Bits 40-63) (Step S124) and the process ends.

If T=1 (virtual address) in Step S121 (No from Step S121), the determining unit 22 determines whether or not Bit 30 (AX) has a value of 0 (Step S125). If AX #0 (i.e., AX=1) (No from Step S125), the determining unit 22 determines whether or not Bits 16-17 (AS) is “11” (Step S126).

If AS=11 (Yes from Step S126), the determining unit 22 determines that the address is an address in the 32-bit HOME space mode (i.e., an instruction address is contained in Bits 32-63) (Step S127) and the process ends.

If AS=11 does not hold true (No from Step S126), the determining unit 22 determines that the address is an address in the 32-bit PRIMARY space mode (i.e., an instruction address is contained in Bits 32-63) (Step S128) and the process ends.

If AX=11 in Step S125 (Yes from Step S125), the determining unit 22 determines whether or not Bit 32 (A) has a value of 0 (Step S129). If A=0 (Yes from Step S129), the determining unit 22 determines whether or not Bits 16-17 (AS) is “11” (Step S130).

If AS=11 (Yes from Step S130), the determining unit 22 determines that the address is an address in the 24-bit HOME space mode (i.e., an instruction address is contained in Bits 40-63) (Step S131) and the process ends.

If AS=11 does not hold true (No from Step S130), the determining unit 22 determines that the address is an address in the 24-bit PRIMARY space mode (i.e., an instruction address is contained in Bits 40-63) (Step S132) and the process ends.

If A=1 in Step S129 (No from Step S129), the determining unit 22 determines whether or not Bits 16-17 (AS) is “11” (Step S133).

If AS=11 (Yes from Step S133), the determining unit 22 determines that the address is an address in the 31-bit HOME space mode (i.e., an instruction address is contained in Bits 33-63) (Step S134) and the process ends.

If AS=11 does not hold true (No from Step S133), the determining unit 22 determines that the address is an address in the 31-bit PRIMARY space mode (i.e., an instruction address is contained in Bits 33-63) (Step S135) and the process ends.

As described above, an instruction address space is determined by the settings in the PSW 241.

<Address Space Determination Process for Operand Address>

Virtual address spaces take either one of the PRIMARY space mode, the SECONDARY space mode, the AR space mode, and the HOME space mode. Therefore, operand address spaces take either one of 10 patterns of space modes by combining the 24/31-bit modes, and the real address/PRIMARY/SECONDARY/AR/HOME modes.

In addition to these, in one embodiment, four patterns of space modes by combining the 32-bit mode and the PRIMARY/SECONDARY/AR/HOME modes, are added to operand address spaces by the support of the 32-bit virtual address function.

As exemplified in FIG. 13, the determining unit 22 determines whether or not Bit 5 (T) in the PSW 241 has a value of 0 (Step S141). If T=0 (real address) (Yes from Step S141), the determining unit 22 determines whether or not Bit 32 (A) has a value of 1 (Step S142).

If A=1 (Yes from Step S142), the determining unit 22 determines that the address is a 31-bit real address (Step S143) and the process ends.

If A=0 (No from Step S142), the determining unit 22 determines that the address is a 24-bit real address (Step S144) and the process ends.

If T=1 (virtual address) in Step S141 (No from Step S141), the determining unit 22 determines whether or not Bit 30 (AX) has a value of 0 (Step S145). If AX #0 (AX=1) (No from Step S145), the determining unit 22 checks Bits 16-17 (AS) (Step S146).

If AS=00 (“00” in Step S146), the determining unit 22 determines that the address is an address in the 32-bit PRIMARY space mode (Step S147) and the process ends. If AS=10 (“10” in Step S146), the determining unit 22 determines that the address is an address in the 32 bit SECONDARY space mode (Step S148) and the process ends.

If AS=01 (“01” in Step S146), the determining unit 22 determines that the address is an address in the 32-bit AR space mode (Step S149) and the process ends. If AS=11 (“11” in Step S146), the determining unit 22 determines that the address is an address in the 32-bit HOME space mode (Step S150) and the process ends.

If AX=0 in Step S145 (Yes from Step S145), the determining unit 22 determines whether or not Bit 32 (A) has a value of 0 (Step S151). If A=0 (Yes from Step S151), the determining unit 22 checks Bits 16-17 (AS) (Step S152).

If AS=00 (“00” in Step S152), the determining unit 22 determines that the address is an address in the 24-bit PRIMARY space mode (Step S153) and the process ends. If AS=10 (“10” in Step S152), the determining unit 22 determines that the address is an address in the 24 bit SECONDARY space mode (Step S154) and the process ends.

If AS=01 (“01” in Step S152), the determining unit 22 determines that the address is an address in the 24-bit AR space mode (Step S155) and the process ends. If AS=11 (“11” in Step S152), the determining unit 22 determines that the address is an address in the 24-bit HOME space mode (Step S156) and the process ends.

If A=1 in Step S151 (No from Step S151), the determining unit 22 checks Bits 16-17 (AS) (Step S157).

If AS=00 (“00” in Step S157), the determining unit 22 determines that the address is an address in the 31-bit PRIMARY space mode (Step S158) and the process ends. If AS=10 (“10” in Step S157), the determining unit 22 determines that the address is an address in the 31-bit SECONDARY space mode (Step S159) and the process ends.

If AS=01 (“01” in Step S157), the determining unit 22 determines that the address is an address in the 31-bit AR space mode (Step S160) and the process ends. If AS=11 (“11” in Step S157), the determining unit 22 determines that the address is an address in the 31-bit HOME space mode (Step S161) and the process ends.

As set forth above, operand address spaces of general instructions are determined by setting values in the PSW 241, except for special instructions including 40-bit real address dedicated instructions (described later).

<<1-2-2>> Dynamic Address Translation (DAT)

(Descriptions on Table Formats Used for DAT)

A dynamic address translation (DAT) is a translation mechanism for translating virtual addresses to real addresses, and is embodied by the translating unit 23, for example. The translating unit 23 makes searches in the segment table 25 and the page table 26, starting at a segment table descriptor (STD) that has been set to a control register, e.g., a CR 243 (refer to FIG. 2) that is one example of a second storing circuit (unit) or a second storing region, to determine a real address, for example. Note that the segment table 25 and the page table 26 are examples of translation information or an address translation table indicating correspondences between virtual storage areas available in the third bit mode (e.g., the 32-bit mode) and real storage areas in the memory 12.

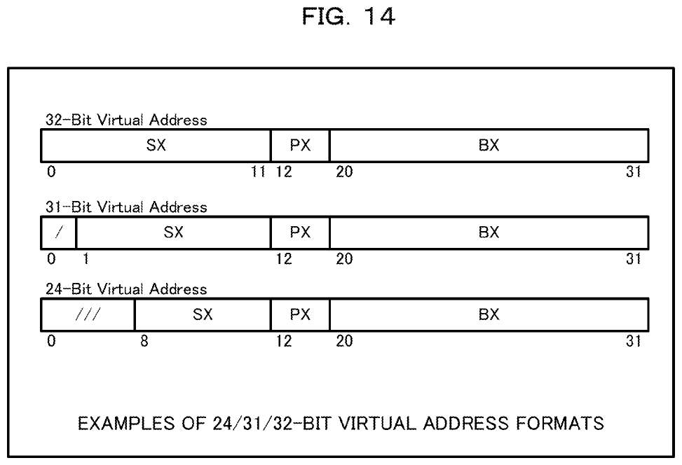

FIG. 14 is a diagram illustrating examples of 24/31/32-bit virtual address formats. As illustrated in FIG. 14, each virtual address includes bit regions of SX, PX, and BX.

<SX>

An SX is used to search the segment table 25 for an entry (segment table entry; STE) having the same number as the SX upon a dynamic address translation. In the 24-bit virtual addressing, Bits 8-11 are used as an SX, whereas in the 31-bit virtual addressing, Bits 1-11 are used as an SX. The 32-bit virtual addressing extends a virtual address to 32 bits, and thus an SX is extended to 12 bits of Bits 0-11.

<PX (Bits 12-19)>

A PX is used to search the page table 26 for an entry (page table entry; PTE) having the same number as the PX upon a dynamic address translation.

<BX (Bits 20-31)>

A BX corresponds to the lower 12 bits of a real address to be determined by a dynamic address translation.

Note that the bit widths of a PX and a BX are constant, irrespective of the bit lengths of virtual addresses.

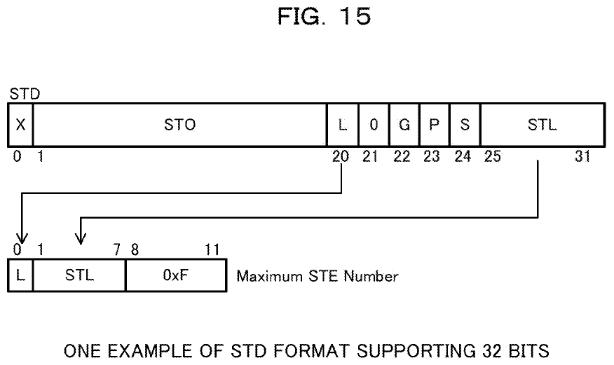

FIG. 15 is a diagram illustrating one example of the STD format. An STD is information that manages and defines the segment table 25 and is used to search the address translation table, and may include information, such as the head address of the segment table 25 and the maximum entry number (entry count) in the table. As illustrated in FIG. 15, the STD includes bit areas of a segment table origin (STO) and a segment table length (STL).

<STO (Bits 1-19)>

An STO is used to determine the head address of the segment table 25. For example, the head address of the segment table 25 is determined by appending a 12-bit array of 0 to the right of the STO.

<STL (Bits 25-31)>

An STL is used to determine the maximum entry number in the segment table 25. In other words, the storage area assigned as the STL is one example of a definition area to which an entry count corresponding to the capacity of virtual storage areas available in the second bit mode (e.g., the 31-bit mode) is set. Note that, when 32-bit virtual addresses are not supported, the maximum entry number in the segment table 25 is determined by multiplying the value in an STL by 16 and then adding 15, for example.

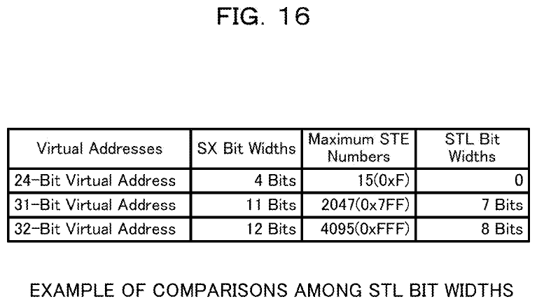

On the other hand, the extended SX bit width of 32-bit virtual addresses increases the entry count in the segment table 25. When the SX is extended to 12 bits, the maximum entry number is increased to 4095 (0xFFF). In addition, because the maximum entry number is determined by (the value of an STL in an STD x 16+15), the maximum value of an STL is 255 (0xFF) and the bit width of the STL is 8 bits (refer to FIG. 16). In other words, for supporting 32-bit virtual addresses, the bit width of the STL is to be extended by one bit.

Because Bit 24 in an STD has been reserved, it cannot be used for a bit extension of the STL. Hence, in one embodiment, the STL is extended to 8 bits by using Bit 20 (L) instead of Bit 24. The storage area assigned as Bit 20 (L) is one example of an extension area (L). Note that, because Bit 20 is not reserved in the conventional functions (24/31-bit virtual addresses), the conventional functions are not affected even when Bit 20 is used.

As exemplified in FIG. 15, the maximum segment table entry (STE) number is determined as the value defined by concatenating Bit 20 (L) and a conventional 7-bit STL, and then concatenating 4-bit “1111” (15) to the right.

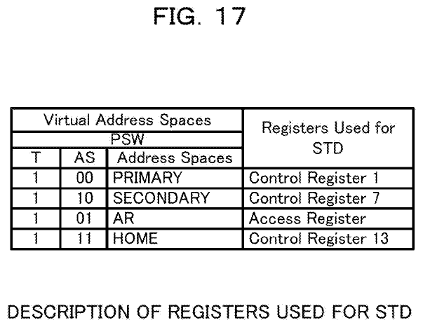

Note that, as exemplified in FIG. 17, STDs used in a dynamic address translation make references to different control registers or access registers (e.g., CR 243 or AR 244) for respective address spaces. Note that the STD formats in all registers may be the same. Note that an access register (e.g., AR 244) is a register used to access an AR space.

No modification is made to registers that are made references to, irrespective of whether 32-bit virtual addresses are supported or not. However, when 32-bit virtual addresses are supported, the STD format is provided with a new definition of Bit 20 (L) as described above.

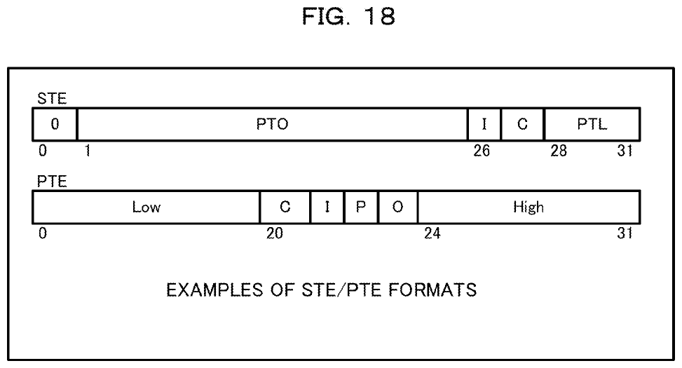

FIG. 18 is a diagram illustrating one example of the STE and PTE formats. As illustrated in FIG. 18, the STE has bit areas of a page table origin (PTO) and a PTL, and the PTE has bit areas of Low and High.

<PTO (Bits 1-25)>

The PTO is used to determine the head address of the page table 26. For example, the head address of the page table 26 is determined by adding a 6-bit array of values of 0 to the right of the PTO.

<PTL (Bits 28-31)>

The PTL is used to determine the maximum entry number in the page table 26. For example, the maximum entry number in the page table 26 is determined by multiplying the PTL by 16 and then adding 15.

<High (Bits 24-31)/Low (Bits 0-19)>

High and the Low correspond to Bits 0-7 and Bits 8-27 of a real address to be determined by a dynamic address translation, respectively. Note that values of 0 are stored to High when 40-bit real addresses are disabled.

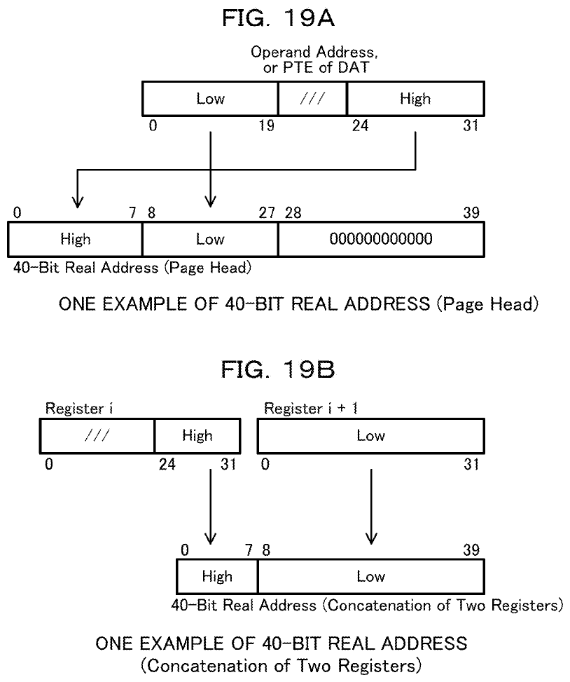

FIGS. 19A and 19B are diagrams each illustrating one example of a 40-bit real address. A 40-bit real address is used as operand addresses of dedicated instructions, or in entries in the page table 26 (PTEs) for a DAT.

A 40-bit real address dedicated instruction may specify a page head in an operand address. Note that one page has a size of 4 KB, for example. In addition, a PTE of the DAT specifies a page head. In this case, a 40-bit real address has the format exemplified in FIG. 19A.

Alternatively, a 40-bit real address dedicated instruction may specify a 40-bit real address defined by concatenating two registers. In such a case, the 40-bit real address has the format exemplified in FIG. 19B.

(Exemplary Operations of Address Translation Process)

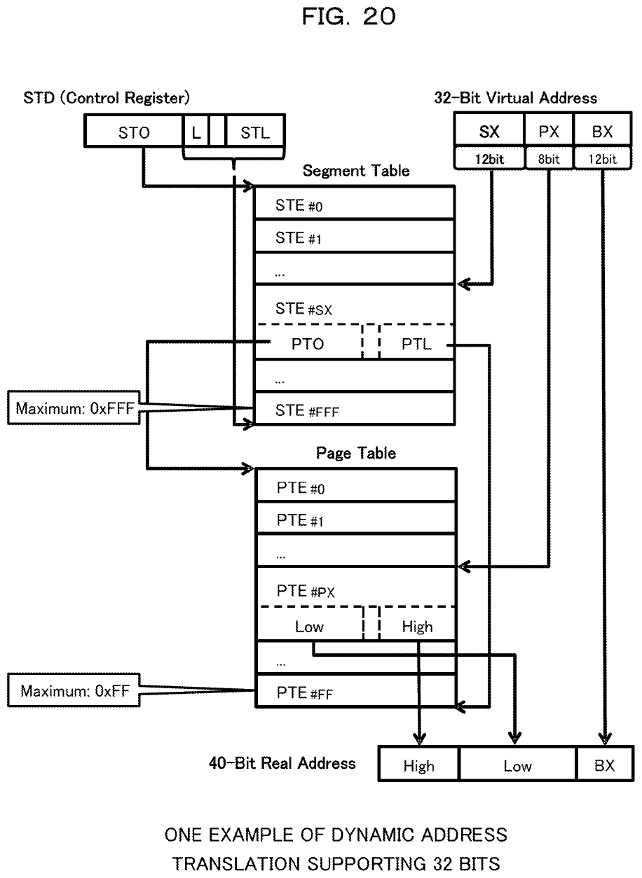

Next, referring to FIG. 20, exemplary operations of an address translation process will be described. The translating unit 23 translates a virtual address to a real address by means of a dynamic address translation (DAT).

As exemplified in FIG. 20, the translating unit 23 divides a 32-bit virtual address into three areas of SX, PX, and BX, searches for an STE that matches the value of the SX and a PTE that matches the value of the PX, and determines a real address using the BX.

In the search for an STE, the translating unit 23 may make a reference to an STD set in a CR 243, and determine the head address of the segment table 25 based on an STO in the STD, for example. Note that the maximum entry number in the segment table 25 is determined based on an 8-bit value defined by concatenating Bit 20 (L) and Bits 25-31 (STL) in the STD.

Furthermore, in the search for a PTE, the translating unit 23 may determine the head address of the page table 26 based on a PTO in the STE identified in the search, for example. Note that the bit width of PX is not changed and the entry count in the page table 26 is not increased from the conventional functions (supports of 24/31-bit virtual addresses).

Furthermore, in order to determine a real address, the translating unit 23 may translate a 32-bit virtual address to a 40-bit real address by concatenating High and Low in the PTE identified in the search, and the BX, for example.

Note that, as described above, the support of the 32-bit virtual address function extends the bit width of virtual addresses to 32 bits, which results in an extension of the bit width of SX to 12 bits (refer to FIG. 14).

Although the extension of SX increases the entry count of the segment table 25 from 2048 entries to 4096 entries, the specification of the conventional functions does not allow the entry count exceeding 2048 because the entry count is restricted by an STL in the STD.

To address this, in one embodiment, as described above, an increase in the entry count of the segment table 25 is made possible by providing an STD with the new L bit, thereby mitigating the restriction on the entry count. In other words, by supplementing the calculation algorism of the maximum entry count with L bit in the STD, the entry number is increased up to 4096 entries (the maximum entry number is increased to 4095 (0xFFF)).

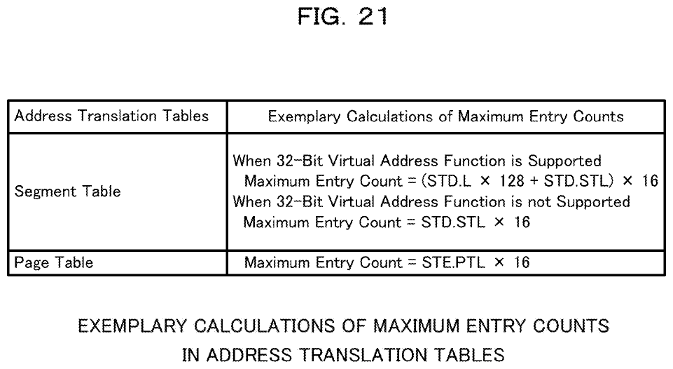

As exemplified in FIG. 21, the maximum entry count of the segment table 25 is determined as a value obtained by multiplying an 8-bit value defined by concatenating Bit 20 (L) and Bits 25-31 (STL) in an STD for supporting the 32-bit virtual address function, by 16.

Note that, when the 32-bit virtual address function is not supported, the maximum entry count is determined by multiplying Bits 25-31 (STL) in an STL by 16.

In contrast, the maximum entry count of the page table 26 is determined by multiplying Bits 28-31 (PTL) in an STE by 16, irrespective of whether the 32-bit virtual address function is supported or not.

Note that, for entries of both an STE and a PTE, when the value of an SX or PX of a virtual address exceeds the maximum entry count, a dynamic address translation fails as a translation exception.

In this manner, the translating unit 23 is one example of an address translating circuit (unit) or a translating controller configured to translate a virtual address to a real address in the memory 12 based on an address translation table and a concatenated address (Bits 32-63). With this, the processing unit 21 as an access circuit (unit) can access the real address translated by the translating unit 23.

Furthermore, it can be regarded that the translating unit 23 performs an address translation, based on an extended entry count defined by concatenating an entry count set in an STL and a value set in an extension area in a CR 243; the address translation table; and the concatenated address, when the 32-bit mode is enabled.

As set forth above, a dynamic address translation (DAT) of a 32-bit virtual address is different from the conventional (24/31-bit) operations in terms of the additional bit L in the STD, the increase in the entry count in the segment table 25, and the like, achieved by increasing the bit width of an SX. Note that operations that have not been particularly described may be similar to those in the conventional (24/31-bit) operations.

As set forth above, in the computer system in accordance with one embodiment, an enable bit for the 32-bit virtual address function is provided to the PSW 241. With this modification of the PSW format, when the enabled bit has a value of 1, the CPU 11 handles a virtual address as a 32-bit address, and handles the bit for determining the 24/31-bit modes as a part of the address. In contrast, when the enabled bit has a value of 0, the CPU 11 handles the virtual address as a 24/31-bit address in the same manner as the conventional techniques.

In addition, in the computer system 1 in accordance with one embodiment, because the 32-bit mode is added to address space determinations, the CPU 11 determines the bit width of a virtual address of an instruction address or an operand address based on information in the PSW 241. With this, it is possible to allow the bit widths to support three modes, i.e., the conventional 24/31-bit modes, and the additional 32-bit mode.

Furthermore, in the computer system 1 in accordance with one embodiment, by adding one bit to an STD, an STL used in an address translation is extended to 8 bits. This extension enables the entry count of the segment table 25 to be increased, thereby allowing virtual addresses to support 32 bits.

<<1-3>> Descriptions on Support Information

The bit widths of address spaces are determined by the setting value in the PSW 241, and the settings in the PSW 241 may be controlled based on support information.

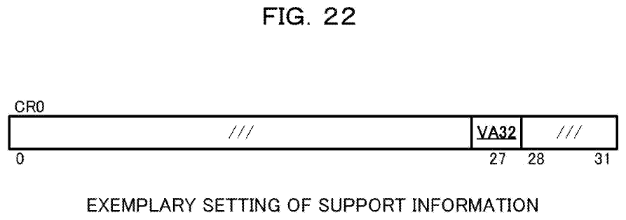

As exemplified in FIG. 22, the support information of the 32-bit virtual address function in accordance with one embodiment may be stored in a CR 243 (“CR0” as one example) in the storing unit 24.

As illustrated in FIG. 22, the support information may be provided in Bit 27 (VA32) in a CR 243 (CR0), for example. A value of 0 in VA32 indicates that the 32-bit virtual address function is disabled, and the address space operates in the conventional functions (24/31 bits). In contrast, the 32-bit virtual address function is enabled when VA32 has a value of 1, and the address space operates on the conventional functions plus a new function, i.e., 24/31/32 bits.

By adding the 32-bit virtual address function to the support information, operations of hardware (e.g., circuit logics of the determining unit 22 and the translating unit 23) can be switched upon computations of the PSW format and the maximum entry count of an address translation table.

In addition, by providing the support information in VA32, the OS and applications can switch between the conventional compatibility mode and the 32-bit address space mode.

<<1-4>> Descriptions on Software (SW) Setting

As set forth above, the OS and applications can switch the width of an address space among 24 bits, 31 bits, and 32 bits in accordance with settings in CR0 and the PSW 241. Note that, for making the entire system operate in the conventional compatibility mode, support information in CR0 may be set to “Disabled”. In the following descriptions, it is assumed that the processing unit 21 in the CPU 11 executes various instructions that will be described later by executing programs stored in the memory 12.

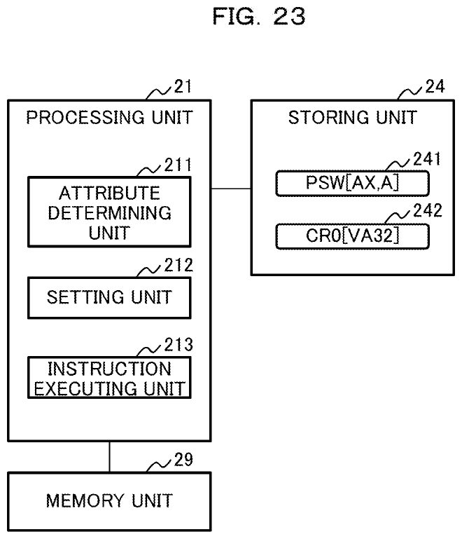

FIG. 23 is a diagram illustrating an exemplary functional configuration of the processing unit 21. As illustrated in FIG. 23, the processing unit 21 may include an attribute determining unit 211, a setting unit 212, and an instruction executing unit 213, as an example.

The attribute determining unit 211 determines an attribute of an application to which a CPU instruction execution permission is given, e.g., an application that is to be executed by the instruction executing unit 213. The attribute is the address mode (bit mode) in which the application operates (which is supported by the application), including the 24-bit mode, the 31-bit mode, and the 32-bit mode, for example.

Note that, when the support information in CR0 in the storing unit 24 indicates “Disabled” (when VA32 in CR0=0), the attribute determining unit 211 may determine as the 31- (or 24-) bit mode even if the attribute of an application indicates the 32-bit mode. Alternatively, the attribute determining unit 211 may determine the attribute of an OS to which a CPU instruction execution permission is given.

In this manner, the attribute determining unit 211 is one example of a determining circuit (unit) or a determining controller configured to determine a bit mode in which a first program associated with an instruction is to be executed by the CPU 11, operates.

The setting unit 212 is one example of a setting circuit or a setting controller, and may make the following settings in the PSW 241 in the storing unit 24 in accordance with the attribute determined by the attribute determining unit 211, when a CPU instruction execution permission is given to an application (or the OS).
When the attribute indicates the 32-bit mode, the setting unit 212 sets a value of 1 (Enabled) to AX bit.
When the attribute indicates the 31-bit mode, the setting unit 212 sets a value of 0 (Disabled) to AX bit and a value of 1 (Enabled) to A bit.
When the attribute indicates the 24-bit mode, the setting unit 212 sets a value of 0 (Disabled) to AX bit and a value of 0 (Disabled) to A bit.

In addition, the setting unit 212 may set an instruction address or an operand address in the address area in the PSW 241. In this case, when the attribute indicates the 32-bit mode, the setting unit 212 may set a part (extended part) of an extended address (32-bit virtual address) to A bit, thereby utilizing A bit as a part of an address.

In this manner, it can be regarded that the setting unit 212 sets information indicating “Enabled” to AX bit, and sets a concatenated address to A bit and the address area, in the PSW 241, when the bit mode determined by the attribute determining unit 211 is the 32-bit mode.

Prior to processing by the instruction executing unit 213, settings in the PSW 241 for carrying out the above-described processes for the 32-bit mode can be made in a reliable manner by the attribute determining unit 211 and the setting unit 212 for each of programs (e.g., the OS and applications).

The instruction executing unit 213 executes the instruction of the application (or the OS) to which the CPU instruction execution permission is given, by employing an address space in the memory unit 29 as one example of the memory 12.

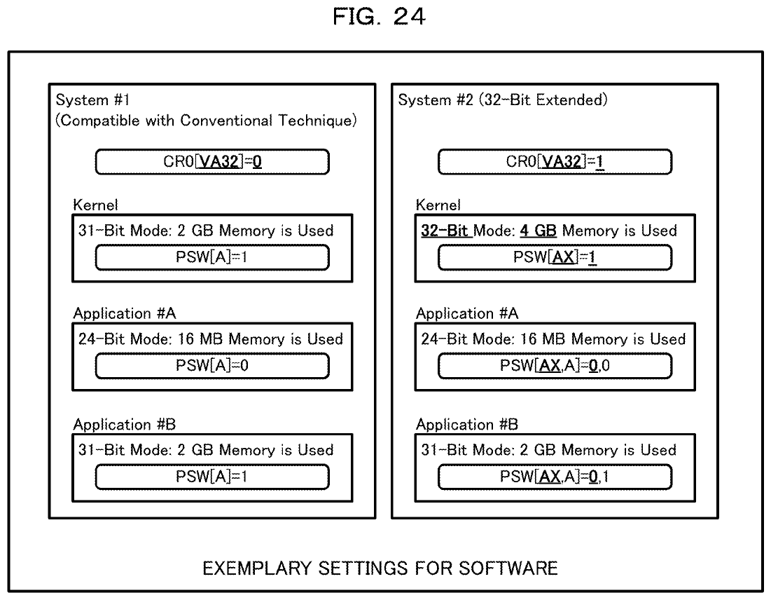

FIG. 24 is a diagram illustrating exemplary settings for software. As exemplified in FIG. 24, System #1, which has support information in CR0 set to “Disabled”, operates in the conventional compatibility mode. System #2, which has support information in CR0 set to “Enabled”, operates in the 32-bit extended mode. Note that the “system” may refer to a computer operated by a single CPU 11, a single cluster 10, or a single virtual machine (VM), or the like.

In the example in FIG. 24, on System #1, the kernel, Applications # A and # B operate in the 24-bit or the 31-bit mode. In contrast, in System #2, the kernel operates in the 32-bit mode, and Applications # A and # B operate in the 24-bit or the 31-bit mode.

As exemplified in FIG. 24, the instruction executing unit 213 may execute instructions of the kernel and the applications in the address modes in accordance with setting values in CR0 and the PSW 241.

When instructions are executed by the instruction executing unit 213, the address space determination process and the address translation process described above may be executed by the determining unit 22 and the translating unit 23 in accordance with control information set by the setting unit 212, as exemplified in FIG. 4.

Note that the memory unit 29 may store a program for embodying all or a part of the functions by the CPUs 11 (e.g., the processing units 21). For example, each CPU 11 can embody the functions as the processing unit 21, by reading a program stored in an I/O device 16 or an unillustrated recording medium, expanding it into the memory unit 29, and executing the program. The functions as the processing unit 21 may include the functions of the attribute determining unit 211, the setting unit 212, and the instruction executing unit 213 described above. Note that the computer system 1 may include devices, such as an adaptor, a card reader, and a drive apparatus, for reading the program from the recording medium.

Examples of the recording medium may include non-transitory recording media, such as magnetic/optical disks and flash memories, for example. Examples of magnetic/optical disks may include flexible disks, compact discs (CDs), digital versatile discs (DVDs), Blu-ray Discs, and holographic versatile discs (HVDs), for example. Examples of flash memories may include semiconductor memories, such as USB memories and SD cards, as an example. Note that examples of CDs may include CD-ROMs, CD-Rs, and CD-RWs, as an example. Further, examples of DVDs may include DVD-ROMs, DVD-RAMs, DVD-Rs, DVD-RWs, DVD+Rs, and DVD+RWs, as an example.

Note that the functions as the processing unit 21 may be embodied by hardware, such as processing circuits, for example, in place of software.

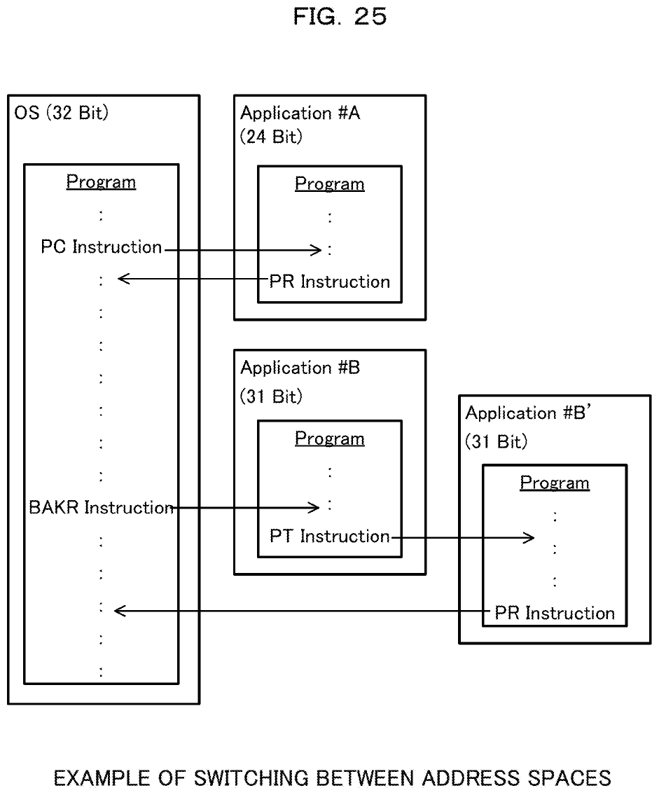

In the meantime, because the OS and applications have respective address spaces as illustrated in FIG. 24, a switching between the address spaces of the OS and applications occurs as illustrated in FIG. 25. Examples of address space switching instructions for switching between address spaces include the PROGRAM CALL (PC) instruction, the BRANCH AND STACK (BAKR) instruction, the PROGRAM TRANSFER (PT) instruction, and the PROGRAM RETURN (PR) instruction, for example.

In one embodiment, switching to the 32-bit virtual address mode is enabled by supplementing these address space switching instructions with information about a 32-bit virtual address. Hereinafter, details of instructions, and exemplary executions of the instructions by the instruction executing unit 213 will be described.

<PROGRAM CALL (PC) Instruction>

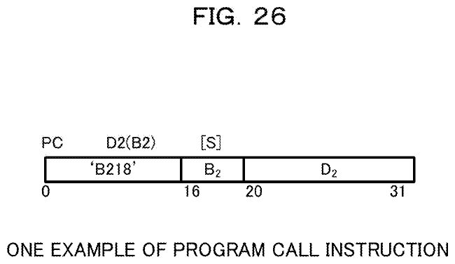

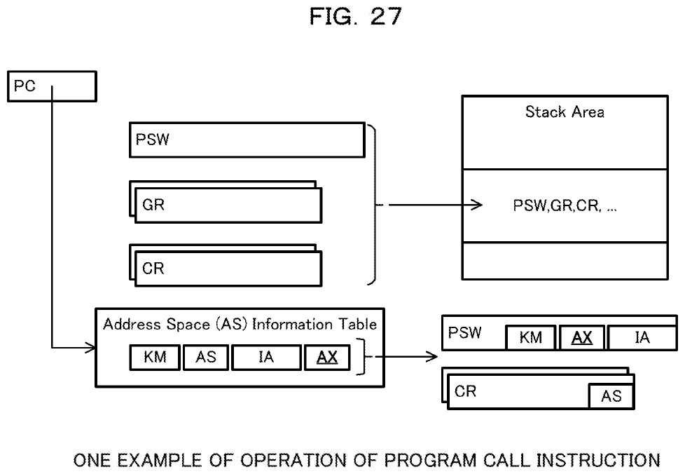

FIG. 26 is a diagram illustrating one example of the PC instruction, and FIG. 27 is a diagram illustrating one example of an operation of the PC instruction. As illustrated in FIG. 27, the PC instruction saves the contents of the current CPU environment (e.g., the PSW 241, the GRs 242, and the CRs 243) into the stack area 28 in the memory 12 (refer to FIG. 3), as well as reflecting the content in an Entry-Table entry specified in the second operand, to a new CPU environment. For example, the processing unit 21 reflects information in KM bit, IA bit, and AX bit to the PSW 241, and reflects information in AS bit to a CR 243, of information in the AS information table 27. Note that KM is an abbreviation of PSW-key Mask, IA is an abbreviation of Instruction Address, and AS is an abbreviation of Address Space Number.

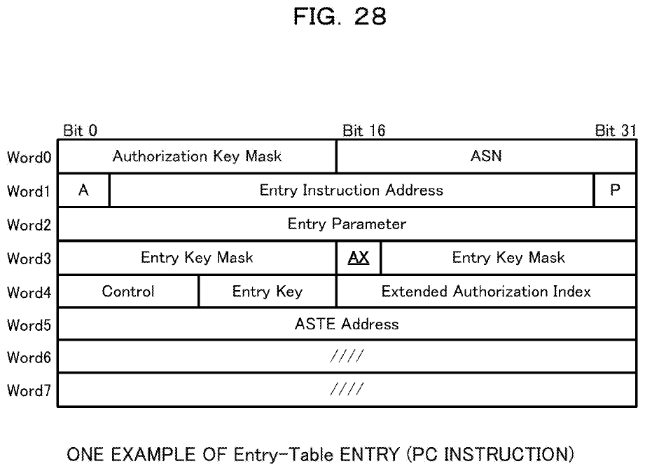

In one embodiment, the support of the 32-bit virtual address function modifies the format of an Entry-Table entry. For example, as illustrated in FIG. 28, a new definition of Bit 16 (AX) is provided to Word 3 in the Entry-Table entry, such that the 32-bit virtual address mode can be specified. Note that, because AX bit has had a value of 0 prior to the definitions of the present disclosure, the conventional functions are not affected.

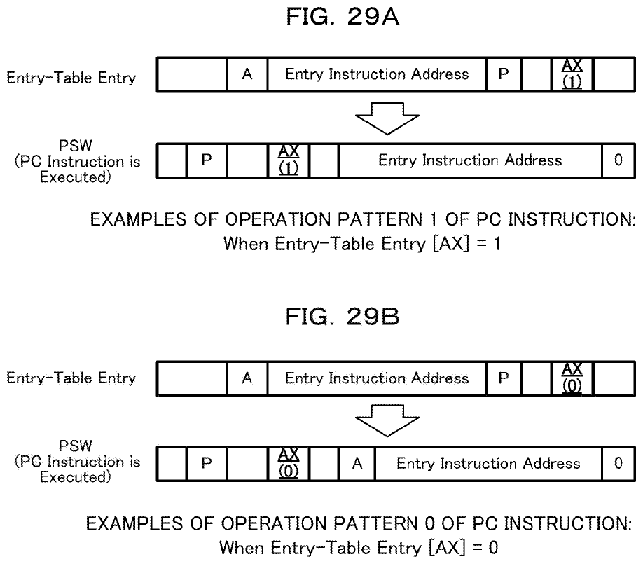

FIG. 29 is a diagram illustrating one example of an operation pattern of the PC instruction. The PC instruction reflects the content in an Entry-Table entry to the PSW 241. Accordingly, as illustrated in in FIGS. 29A and 29B, the support of the 32-bit virtual address function (the addition of AX bit) increases the number of the setting patterns to two: a pattern of AX=1 and a pattern of AX=0.

<BRANCH AND STACK (BAKR) Instruction>

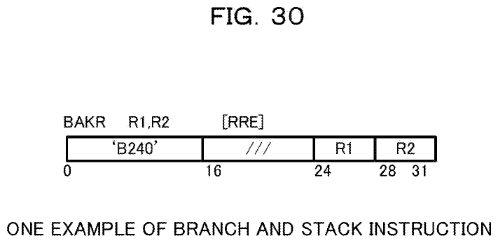

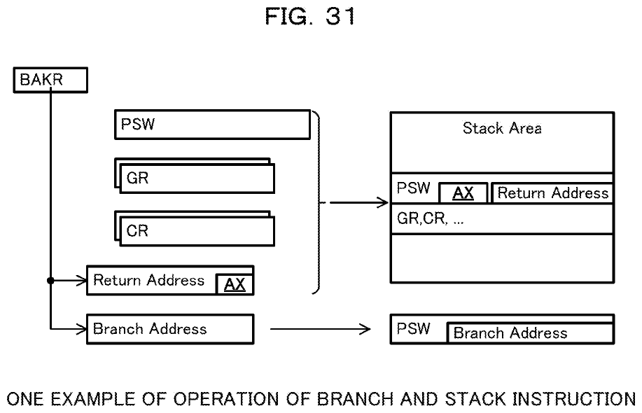

FIG. 30 is a diagram illustrating one example of the BAKR instruction, and FIG. 31 is a diagram illustrating one example of an operation of the BAKR instruction. As illustrated in FIG. 31, the BAKR instruction saves the current CPU environment and the content in the general register (R1) to the stack area 28 in the memory 12 (refer to FIG. 3). In addition, the BAKR instruction reflects the address specified in the general register (R2), to a new instruction address in the PSW 241. The Return Address is set to the general register (R1), and the Branch Address is set to the general register (R2). Note that each GRs 242 may be used as a general register (R1 or R2).

For example, the processing unit 21 provides AX bit to the operand (R1) specified for the BAKR instruction, thereby reflecting it together with the Return Address, to the PSW in the stack area 28. Because the stack information in the stack area 28 is used as recovery information for the PSW, the GRs, the CRs, and the like when the PR instruction is executed, the mode is changed to the 32-bit virtual address mode is at that timing. Note that, the Return Address is an even-numbered address. Thus because AX bit in the operand (R1) prior to the definitions of the present disclosure is assured to have a value of 0, the conventional functions are not affected.

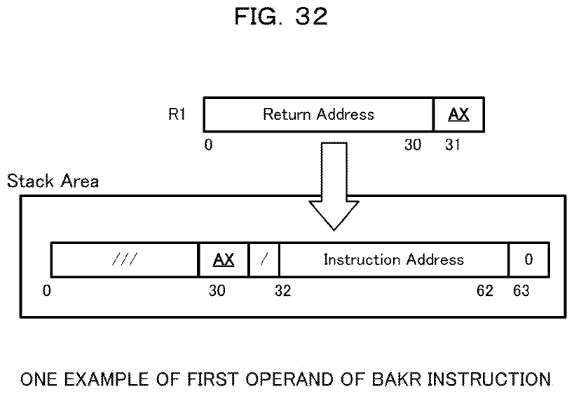

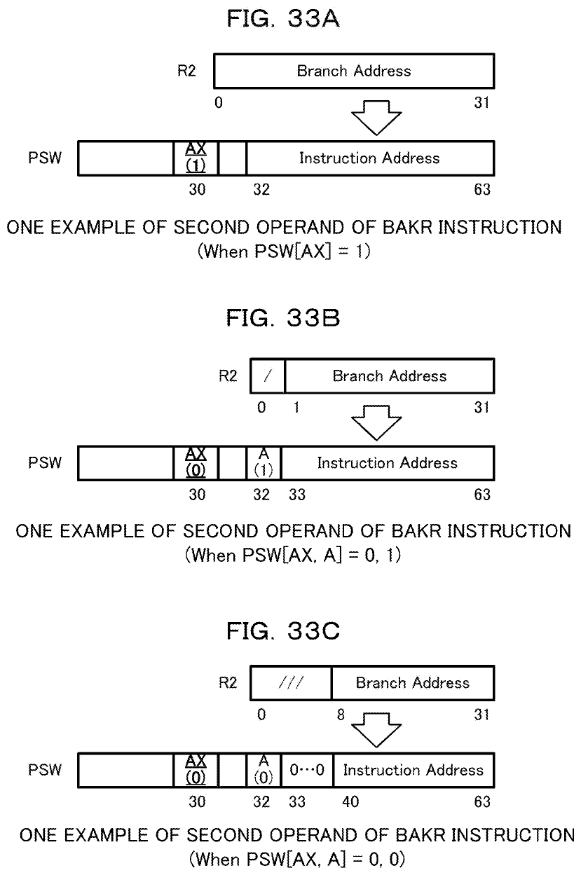

In one embodiment, the support of the 32-bit virtual address function modifies the format of the general register (R1). FIGS. 32 and 33 are diagrams illustrating example of the first operand and the second operand of the BAKR instruction, respectively.

For example, as illustrated in FIG. 32, Bit 30 (AX) is provided to the general register (R1) such that the 32-bit virtual address mode can be specified.

Furthermore, as exemplified in FIG. 33, the processing unit 21 reflects the content in the general register (R2), to the instruction address in the PSW 241. As illustrated in FIGS. 33A-33C, the range of the reflecting varies depending on the value of Bit 30 (AX) and the value of Bit 32 (A) in the PSW 241.
When PSW [AX]=1

When the 32-bit virtual address mode is enabled, as illustrated in FIG. 33A, the Branch Address (0^{th} to 31^{st} bits) in the general register (R2) is set to the Instruction Address (32^{nd} to 63^{rd} bits) in the PSW 241.
When PSW [AX, A]=0, 1

When the 32-bit virtual address mode is disabled and the mode is the 31-bit mode, as illustrated in FIG. 33B, the Branch Address (1^{st} to 31^{st} bits) in the general register (R2) is set to the Instruction Address (33^{rd} to 63^{rd} bits) in the PSW 241.
When PSW [AX, A]=0, 0

When the 32-bit virtual address mode is disabled and the mode is the 24-bit mode, as illustrated in FIG. 33C, the Branch Address (8^{th} to 31^{st} bits) in the general register (R2) is set to the Instruction Address (40^{th} to 63^{rd} bits) in the PSW 241. Note that values of 0 are set to the 33^{rd} to 39^{th} bits in the PSW 241.

<PROGRAM TRANSFER (PT) Instruction>

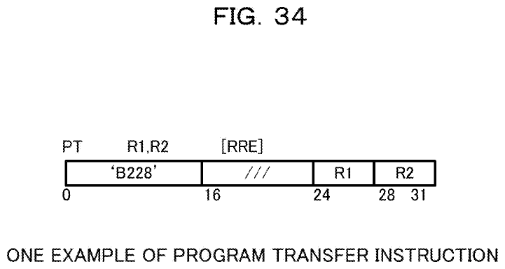

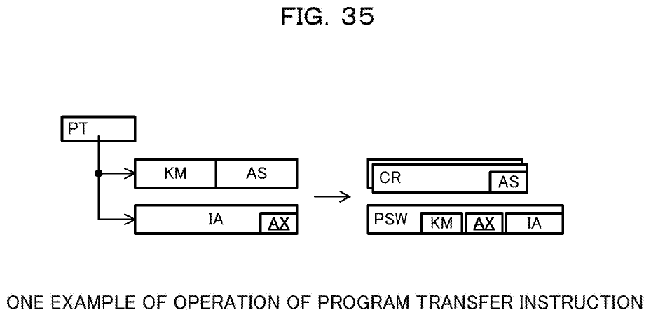

FIG. 34 is a diagram illustrating one example of the PT instruction, and FIG. 35 is a diagram illustrating one example of an operation of the PT instruction. As illustrated in FIG. 35, the PT instruction reflects the contents of the general registers (R1 and R2), to a new CPU environment (the PSW 241 and a CR 243). For example, the processing unit 21 reflects KM bit and AS bit set in the general register (R1) to the PSW 241 and a CR 243, respectively, and reflects IA bit set in the general register (R2) to the PSW 241.

For example, the processing unit 21 provides a value to AX bit in the operand (R2) specified for the PT instruction, such that that value of AX bit is reflected to the PSW 241. IA is an even numbered address. Thus, because AX bit in the operand (R2) prior to the definitions of the present disclosure is assured to have a value of 0, the conventional functions are not affected.

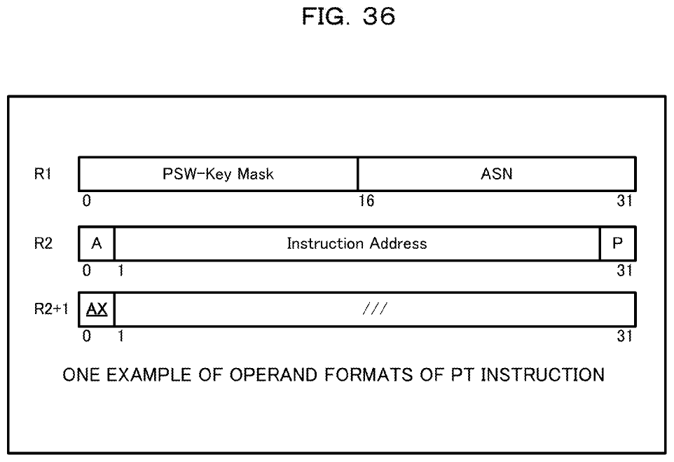

In one embodiment, the support of the 32-bit virtual address function may use or add an additional new general register (R2+1). FIG. 36 is a diagram illustrating one example of the operand formats of the PT instruction. As illustrated in FIG. 36, Bit 0 (AX) in the general register (R2+1) permits designation of the 32-bit virtual address mode.

<PROGRAM RETURN (PR) Instruction>

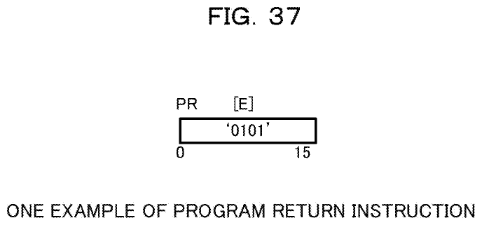

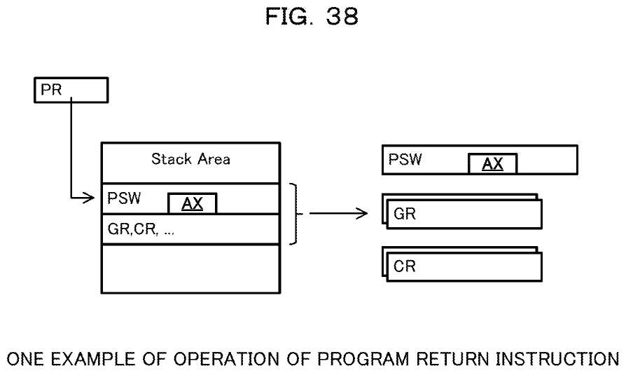

FIG. 37 is a diagram illustrating one example of the PR instruction, and FIG. 38 is a diagram illustrating one example of an operation of the PR instruction. The PR instruction reads information saved in the stack area 28, and reflects it to the CPU environment (e.g., the PSW 241, the GRs 242, and the CRs 243). Because the contents in the PSW 241 has been saved in the stack area 28, information on the 32-bit virtual address mode is also reflected.

As described above, the PR instruction recovers contents in the PSW 241, the GRs 242, the CR 243, and the like, from the stack information in the stack area 28.

As set forth above, because the modifications to the PC instruction, the BAKR instruction, and the like, makes it possible to save information in AX bit into the stack information, the 32-bit virtual address mode can be set to the PR instruction by means of the information in AX bit.

<General Instructions>

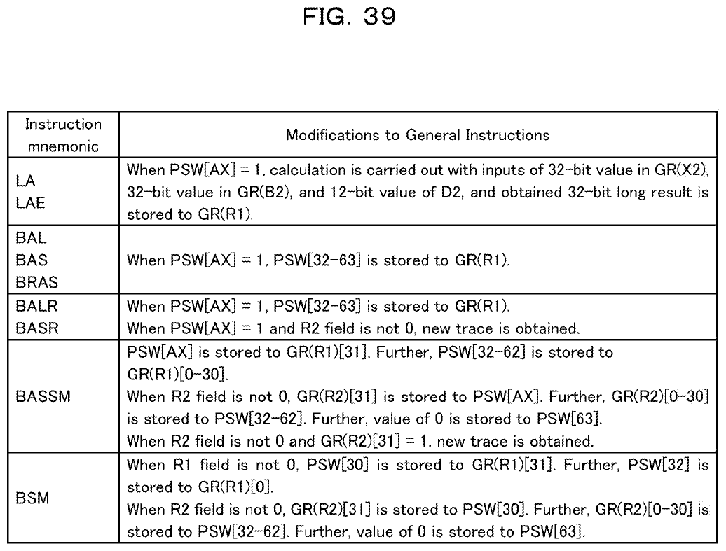

In one embodiment, as exemplified in FIG. 39, the support of the 32-bit virtual address function modifies processing of several general instructions.

<Control Instructions>

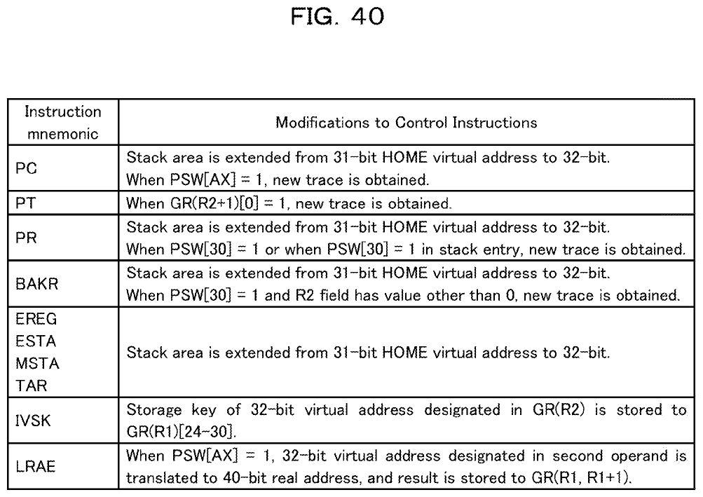

In one embodiment, as exemplified in FIG. 40, the support of the 32-bit virtual address function modifies processing of several control instructions. Note that such control instructions include the PC instruction, the BAKR instruction, the PT instruction, and the PR instruction, described above.

As set forth above, upon switching to a second program associated with a second instruction to be executed by the CPUs 11, the instruction executing unit 213, i.e., the processing unit 21 as an access controller includes information (AX) indicating whether the 32-bit mode is enabled or disabled, to the first instruction or a third instruction instructing the switching. This enables efficient and correct switching between address spaces.

<<1-5>> Channel Subsystem

Next, the channel subsystem 13 in accordance with one embodiment will be described.

After a CPU 11 executes an I/O start instruction, the processing is transitioned to the channel subsystem 13. The destination specified by the operand address of the I/O start instruction contains an operation request block (ORB), in which the detail of an instruction to an I/O device 16 is stored. The channel subsystem 13 executes the instruction the I/O device 16 in accordance with the detail in the ORB as one example of the control information. Execution processes of instructions by the channel subsystem 13 may be fundamentally the same as execution processes of instructions by the CPUs 11, except in that an ORB is used in place of the PSW 241, the type of addresses, and execution targets of instructions, and the like are different.

(Exemplary Configuration)

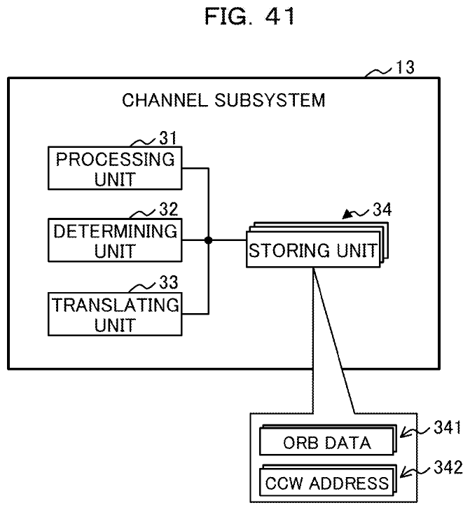

As illustrated in FIG. 41, the channel subsystem 13 may include a processing unit 31, a determining unit 32, a translating unit 33, and storing units 34, as an example. The processing unit 31, the determining unit 32, the translating unit 33, and the storing unit 34 may be similar to the processing unit 21, the determining unit 22, the translating unit 23, and the storing unit 24, unless otherwise stated in the following. In other words, for the configuration and operations of the channel subsystem 13, the following descriptions can be read with reference to corresponding descriptions on the configuration and operations of the CPUs 11 described above.

The processing unit 31 executes an I/O on an I/O device 16 by executing various instructions, such as the I/O start instruction from a CPU 11. In one embodiment, similar to the processing unit 21, the processing unit 31 makes the 32-bit mode enhancingly available for addressing to virtual storage areas, in addition to the 24-bit and 31-bit modes that are available conventionally. In other words, the channel subsystem 13 can support an OS and applications operating in the 32-bit mode, in addition to supporting an OS and applications operating in the 24-bit or the 31-bit mode.

The determining unit 32 determines the type of address spaces of channel command words (CCW) addresses and data addresses. For example, the determining unit 32 may make determinations on 24-bit, 31-bit, and 32-bit address spaces.

The translating unit 33 performs a translation of a CCW address or a data address in accordance with the address space determined by the determining unit 32. The processing unit 31 may execute processing in accordance with the address translated by the translating unit 33.

Note that, for example, the processing unit 31, the determining unit 32, the translating unit 33, and the multiple storing unit 34 may be embodied by hardware, such as a processing circuit, a determining circuit, a translating circuit, and multiple registers, respectively. The translating unit 33 as the translating circuit may be a circuit having a dynamic address translation (DAT), for example. The multiple storing units 34 as registers may include, for example, areas 341 for storing (saving) respective ORB data and areas 342 for storing (saving) respective CCW addresses.

(Processing by Channel Subsystem)

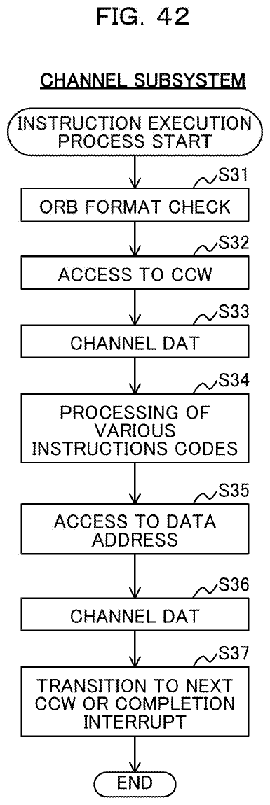

Next, referring to FIG. 42, exemplary operations of an instruction execution process by the channel subsystem 13 will be described. The channel subsystem 13 executes an instruction one by one in accordance with the content in an ORB. FIG. 42 illustrates the procedure to execute a single instruction by the channel subsystem 13.

The determining unit 32 in the channel subsystem 13 checks the format of an ORB included in a I/O start instruction from a CPU 11 (input/output instruction) (Step S31), and determines the type of an address space of a CCW address. The processing unit 31 in the channel subsystem 13 accesses the CCW address (Step S32). The translating unit 33 in the channel subsystem 13 performs an address translation (channel DAT) (Step S33). The processing unit 31 then processes various instruction codes (Step S34).

In addition, the determining unit 32 determines the type of an address space of a data address, and the processing unit 31 accesses the data address (Step S35). The translating unit 33 performs an address translation (channel DAT) (Step S36). The processing unit 31 transitions to the next CCW or issues a completion interrupt on the CPU 11 (Step S37), and the process to execute the single instruction ends.

(Descriptions on Accesses to CCW Address and Data Address)

Next, accesses to a CCW address and a data address by the processing unit 31 and the determining unit 32 will be described.

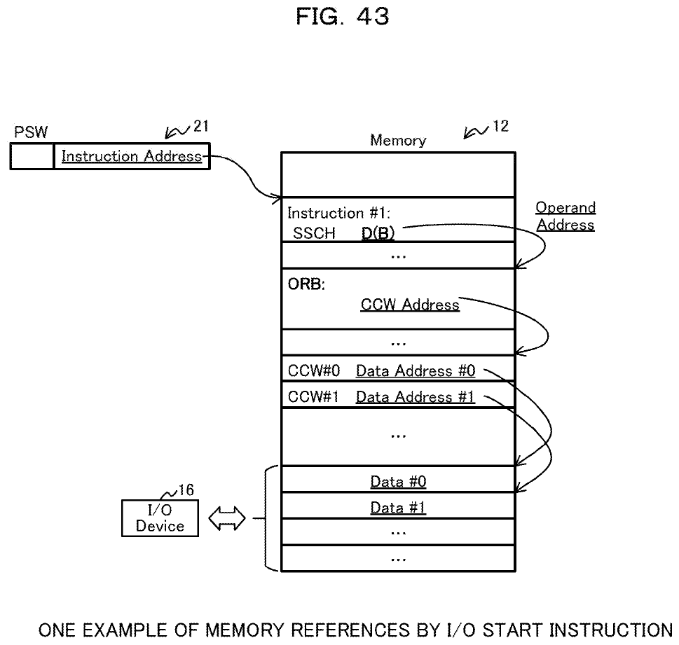

As exemplified in FIG. 43, a CPU 11 reads an I/O start instruction stored in a storage area in the memory 12, which is specified by an instruction address in the PSW 241, and executes the I/O start instruction that is read. In response to the execution of the I/O start instruction, processing by the channel subsystem 13 is carried out.

The ORB specified in the I/O start instruction contains the head address of a CCW, and the CCW contains the addresses of an instruction to an I/O device 16 and data to be sent and/or received. There may be multiple CCWs, and the processing unit 31 can execute multiple instructions on the I/O devices 16 in accordance with multiple CCWs. For example, the processing unit 31 executes instructions on the I/O devices 16 sequentially one by one starting at the first CCW, and issues a completion interrupt to the CPU 11 after processing of all of the CCWs is completed.

Next, details of processing by the channel subsystem 13 will be described, with reference to the procedure to perform the instruction execution process illustrated in FIG. 42.

(Descriptions on ORB Format)

An ORB may store address space information and the head address of a CCW, and the channel subsystem 13 may access the CCW based on the information in the ORB.

Here, an ORB in accordance with one embodiment may be provided with AX bit that is a bit used to enable or disable the 32-bit virtual address mode. The channel subsystem 13 may control 32-bit virtual addressing in accordance with the value of AX bit, thereby the 32-bit virtual address mode is added to address spaces of CCW addresses in the ORB and a data address in each CCW.

AX bit may be Bit 30 (AX) in Word 1, for example. Note that, because Bit 30 in Word 1 is an area to which a value of 0 is set prior to the modifications of the present disclosure (prior to the definitions of the present disclosure), the conventional functions are not affected by the addition of Bit 30 (AX) in Word 1.

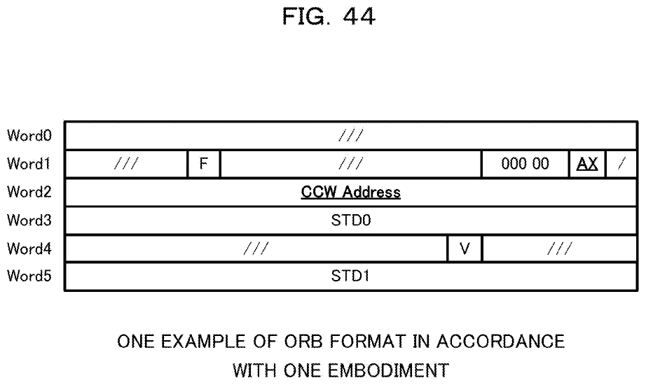

FIG. 44 is a diagram illustrating one example of the format of an ORB in accordance with one embodiment. Hereinafter, each of bits orbit ranges in each Word in the ORB will be described.

<Bit 8 (F) in Word 1>

Bit 8 (F) in Word 1 specifies the address space information of a CCW address or a data address in the CCW. When Bit 8 (F) in Word 1 has a value of 1, the address space contains a 31-bit address. When Bit 8 (F) in Word 1 has a value of 0, the address space contains a 24-bit address. In other words, Bit 8 (F) in Word 1 is used to specify the address spaces to be either one of 24-bit addresses and 31-bit addresses.

<Bits 25-29 in Word 1>

To Bits 25-29 in Word 1, values of 0 are set. When a value other than 0 is set to Bits 25-29 in Word 1, the determining unit 32 reports an exception as an ORB format error.

<Bit 30 (AX) in Word 1>

Bit 30 (AX) in Word 1 is a bit indicating whether the 32-bit virtual address mode is enabled or not. When Bit 30 (AX) in Word 1 has a value of 1, the CCW address or the data address in the CCW functions in the 32-bit mode. Otherwise, when Bit 30 (AX) in Word 1 has a value of 0, the addresses functions in the 24/31-bit mode in the same manner as the conventional techniques, depending on the value of Bit 8 (F) in Word 1.

Setting of Bit 30 (AX) in Word 1 may be restricted such that it can be set to a value of 1 only when Bit 23 (V) in Word 4, which will be described later, has a value of 1 (when virtual addresses are enabled). Note that, if a value of 1 is set to Bit 30 (AX) in Word 1 when Bit 23 (V) in Word 4 has a value of 0 (a virtual address is disabled=real addresses), the determining unit 32 reports an exception as an ORB format error.

The area in the format assigned as Bit 30 (AX) in Word 1 is one example of a third setting area, to which information indicating whether the third bit mode is enabled or disabled is set.

<Bits 0-31 in Word 2 (CCW Address)>

Bits 0-31 or Bits 1-31 in Word 2 specifies the head address of a CCW. When Bit 30 (AX) in Word 1 has a value of 0, addresses of 31 bits at maximum (Bits 1-31 in Word 2) can be specified. In contrast, when Bit 30 (AX) in Word 1 has a value of 1, in one embodiment, a CCW address is extended by one bit and 32 bits of Bits 0-31 in Word 2 can be used as a CCW address.

The area in the format assigned as Bit 0 in Word 2 is one example of an extension area. In addition, the area in the format assigned as Bits 1-31 in Word 2 is one example of an input-output address area, to which an address in the first bit length or the second bit length is set.

<Word 3 (STD0)/Word 5 (STD1)>

Word 3 (STD0) and Word 5 (STD1) are used as STDs for an address translation (channel DAT) of a virtual address when the address space information indicates a virtual address.

<Bit 23 (V) in Word 4>

Bit 23 (V) in Word 4 specifies the address space information of a CCW address or a data address in the CCW. When Bit 23 (V) in Word 4 has a value of 1, the address space contains a virtual address. When Bit 23 (V) in Word 4 has a value of 0, the address space contains a real address.

As set forth above, the channel subsystem 13 may determine the bit width of a virtual address of a CCW address or a data address in accordance with ORB information. The bit widths may support three modes: the 24/31-bit modes and the 32-bit mode.

A CCW has 64-bit data format, for example, and contains information on an instruction to an I/O device 16.

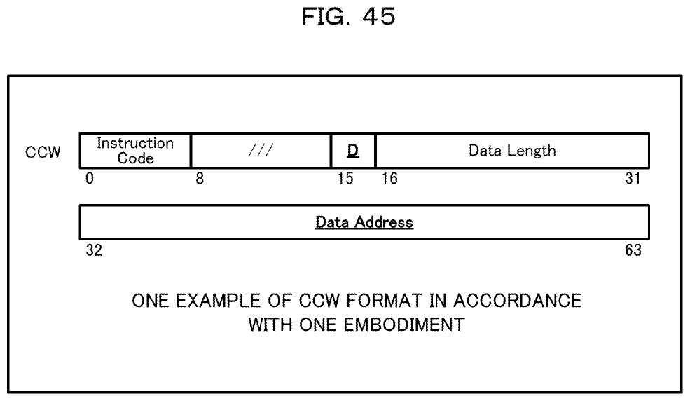

FIG. 45 is a diagram illustrating one example of a CCW format in accordance with one embodiment. Hereinafter, each of bits or bit ranges in a CCW will be described.

<Bits 0-7 (Instruction Code)>

To these bits, an I/O instruction (Read or Write) to an I/O device 16 or the like is specified.

<Bit 15 (D)>

Bit 15 (D) specifies which STDs (i.e., STD0 or STD1) is used for a channel DAT when address space information specifies a virtual address.

<Bits 16-31 (Data Length)>

To these bits, the data transfer length (in byte) used for the I/O instruction is specified.

<Bits 32-63 (Data Address)>

To these bits, the head address of data used in the I/O instruction is specified. A 32-bit address at maximum can be specified to Bits 32-63. The support of 32-bit virtual addresses extends a data address to 32 bits, and 32 bits of Bits 32-63 in the CCW is used to specify the data address when AX in the ORB=1.

In this manner, the processing unit 31 and the determining unit 32 are examples of an input-output access circuit (unit) or an input-output access controller configured to determine a bit mode based on an ORB in response to receiving an input-output instruction from a CPU 11, and to access the memory 12 based on a concatenated address when determined as the 32-bit mode. Note that, as described above, the concatenated address may be a virtual address defined by concatenating the value of Bit 0 in Word 2 (extension area), and the address set in set Bits 1-31 in Word 2 (input-output address area).

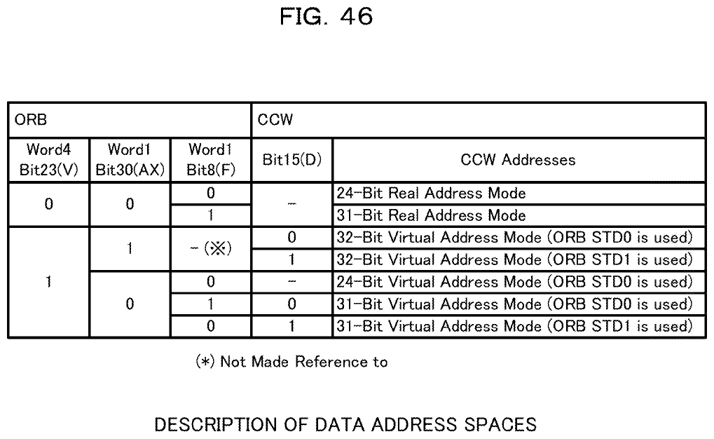

In summary, as exemplified in FIG. 46, a data address space can be identified (determined) from setting information (e.g., V, AX, and F) in an ORB, and an STD used in a channel DAT can be identified (determined) from setting information (e.g., D) in the CCW.

(Exemplary Operations of Determination Process of Address Space)

Next, exemplary operations of a determination process of an address space by the determining unit 32 will be described. For example, the determining unit 32 may determine the types of address spaces during an ORB format check indicated in Step S31, and prior to accesses to a CCW address/data address illustrated in Steps S32 and S35, in FIG. 42.

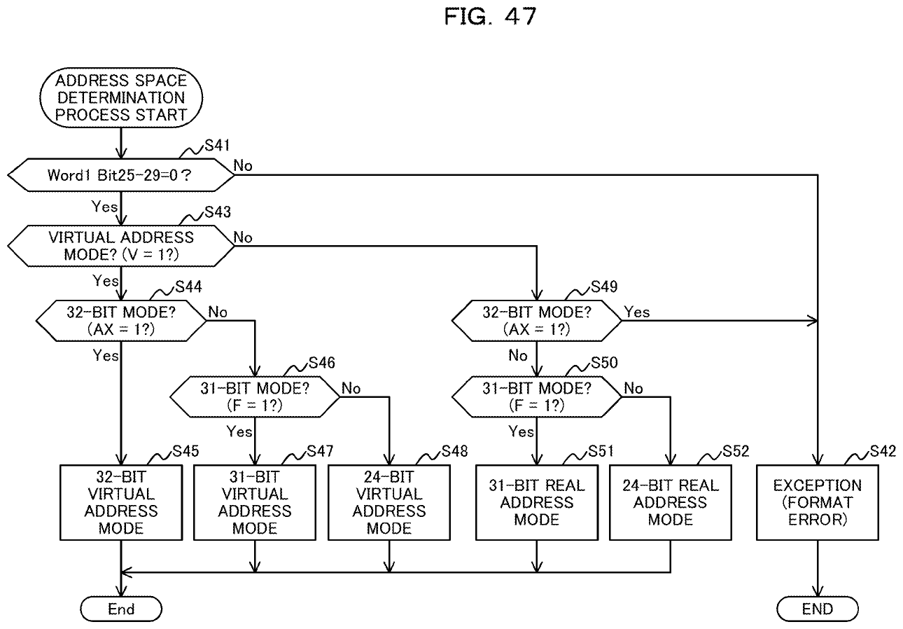

FIG. 47 is a flowchart illustrating exemplary operations of an address space determination process. As illustrated in FIG. 47, the determining unit 32 checks the bits that are defined to have a value of 0 (Step S41). If a value other than 0 is set to any of these bits (No from Step S41), the determining unit 32 reports an exception as the ORB format error (Step S42) and the process ends. Note that, in one embodiment, Bit 30 in Word 1 assigned as AX bit is excluded from the 0 value check in Step S41, as illustrated in FIG. 47.

If all of the bits that are defined to have a value of 0 are set to a value of 0 (Yes from Step S41), the determining unit 32 checks Bit 23 (V) in Word 4 to determine whether or not the virtual address mode is enabled (V=1) (Step S43). If the virtual address mode is enabled (Yes from Step S43), the determining unit 32 checks Bit 30 (AX) in Word 1 to determine whether or not the 32-bit mode is enabled (AX=1) (Step S44).

If the 32-bit mode is enabled (Yes from Step S44), the determining unit 32 determines as the 32-bit virtual address mode (Step S45) and the process ends. In this case, Bit 0 in Word 2 is processed as a part of a CCW address.

If the 32-bit mode is not enabled (AX=0) (No from Step S44), the determining unit 32 checks Bit 8 (F) in Word 1 to determine whether or not the 31-bit mode is enabled (F=1) (Step S46).

If the 31-bit mode is enabled (Yes from Step S46), the determining unit 32 determines as the 31-bit virtual address mode (Step S47) and the process ends.

If the 31-bit mode is not enabled (F=0) (No from Step S46), the determining unit 32 determines as the 24-bit virtual address mode (Step S48) and the process ends.

Otherwise, if in the real address mode (V=0) in Step S43 (No from Step S43), the determining unit 32 checks Bit 30 (AX) in Word 1 to determine whether or not the 32-bit mode is enabled (AX=1) (Step S49).

If the 32-bit mode is enabled (Yes from Step S49), the determining unit 32 reports an exception as the ORB format error (Step S42) and the process ends. This is because the restriction (definition) that Bit 30 (AX) in Word 1 shall have a value of 0 in the real address mode is violated.

If the 32-bit mode is not enabled (AX=0) (No from Step S49), the determining unit 32 checks Bit 8 (F) in Word 1 to determine whether or not the 31-bit mode is enabled (F=1) (Step S50).

If the 31-bit mode is enabled (Yes from Step S50), the determining unit 32 determines as the 31-bit real address mode (Step S51) and the process ends.

If the 31-bit mode is not enabled (F=0) (No from Step S50), the determining unit 32 determines as the 24-bit real address mode (Step S52) and the process ends.

(Example of More Detailed or Alternative Operations of Determination Process of Address Space)

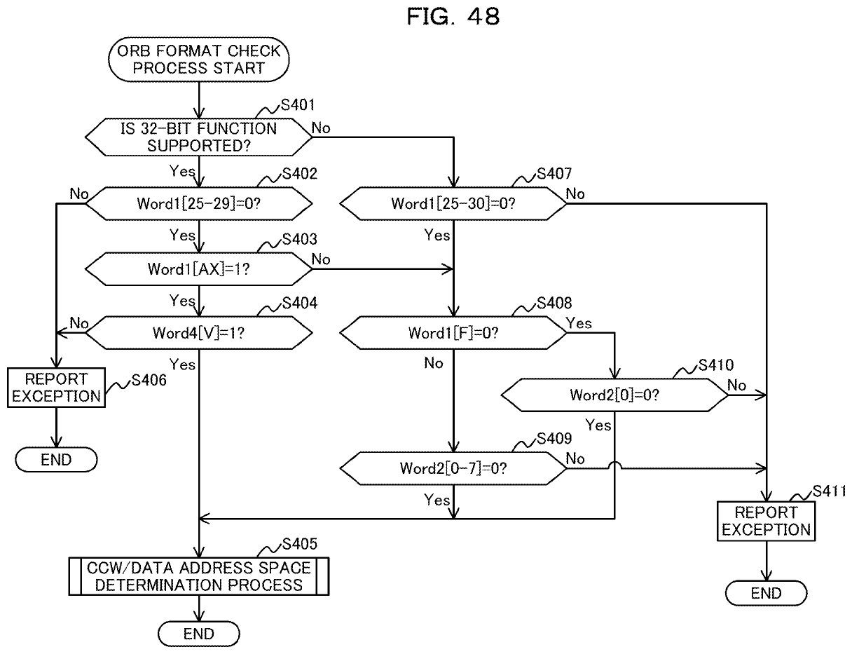

Next, an example of more detailed or alternative operations of the determination process of an address space will be described. FIGS. 48 to 50 are flowcharts illustrating exemplary operations of the ORB format check process, the CCW address space determination process, and the data address space determination process, respectively.

A CCW format check by the determining unit 32 may be modified in accordance with the modification to the ORB format for the 32-bit function (refer to FIG. 44) as follows. Note that the ORB format check may be carried out in accordance with timing to execute an I/O start instruction (e.g., after executing it).

As exemplified in FIG. 48, after the determining unit 32 checks the support information of the 32-bit virtual address function (Step S401), the process may branch to the conventional ORB format check, or to the ORB format check for the 32-bit function, depending on the result of the check.

When the 32-bit virtual address function is supported (Yes from Step S401), the determining unit 32 may execute Steps S402 to S406 as the ORB format check for the 32-bit function. Note that Step S402, S403, and S404 are similar to Steps S41, S44, and S43 in FIG. 47, respectively.

If the determination is No from any of Steps S402 and S404, the determining unit 32 reports an exception of the ORB format (Step S406) and the process ends. If the determination is No from Step S403, the process transitions to Step S408. Otherwise, if the determinations are Yes in all of Steps S401 to S404, the determining unit 32 executes a determination process of an address space of a CCW and/or a data (Step S405) and the process ends.

If the 32-bit virtual address function is not supported (No from Step S401), the determining unit 32 may execute Steps S407 to S411 as the conventional ORB format check.

The determining unit 32 checks the bits that are defined to have a value of 0, including Bit 30 (AX) in Word 1 (Step S407). If all of these bits have a value of 0 (Yes from Step S407), the determining unit 32 determines whether or not Bit 8 (F) in Word 1 has a value of 0 (Step S408).

If F=0 (No from Step S408), the determining unit 32 determines whether or not all of Bits 0-7 in Word 2 have a value of 0 (Step S409). If all of Bits 0-7 in Word 2 have a value of 0 (Yes from Step S409), the process transitions to Step S405.

If F=1 (Yes from Step S408), the determining unit 32 determines whether or not Bit 0 in Word 2 has a value of 0 (Step S410). If Bit 0 in Word 2 has a value of 0 (Yes from Step S410), the processing transitions to 405.

If the determination is No from any of Steps S407, S409, and S410, the determining unit 32 reports an exception of the ORB format (Step S411) and the process ends.

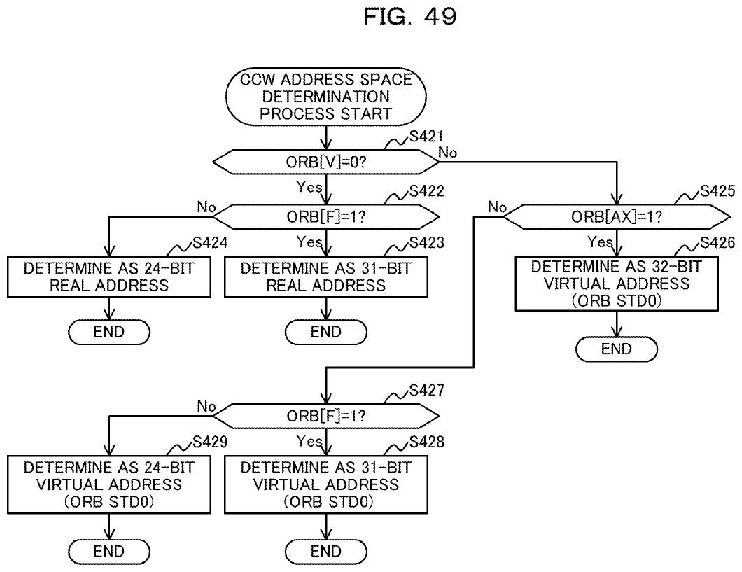

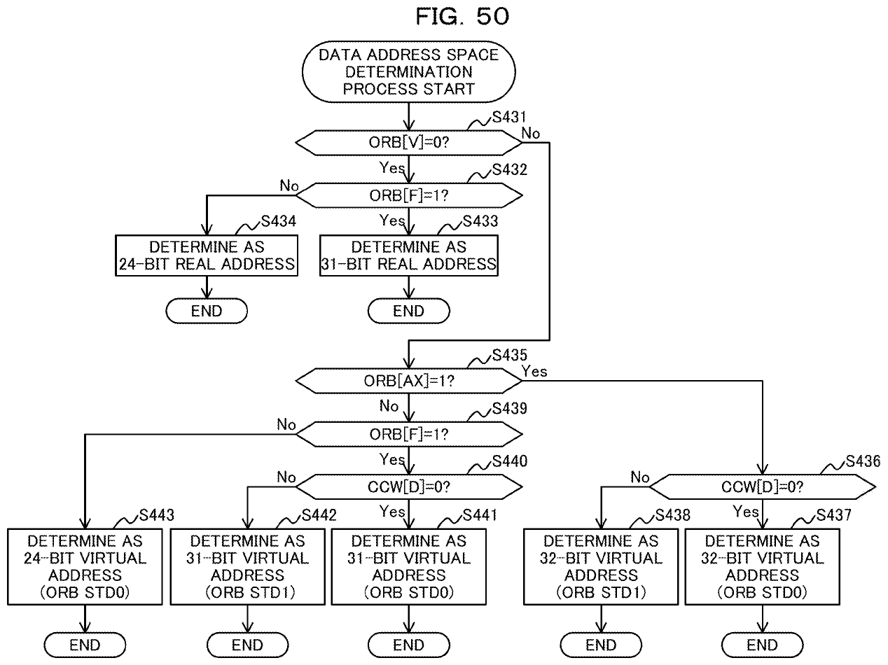

Next, an address space determination process for a CCW address (FIG. 49) and an address space determination process for a data address (FIG. 50), depicted in Step S405, will be described.

<Address Space Determination Process for CCW Address>

An address space of a CCW address is determined by setting information in an ORB, irrespective of setting values in the PSW 241.

As exemplified in FIG. 49, the determining unit 32 determines whether or not V in an ORB=0 (Step S421). If V=0 (real address) (Yes from Step S421), the determining unit 32 determines whether or not F=1 (Step S422).

If F=1 (Yes from Step S422), the determining unit 32 determines that the CCW address is a 31-bit real address (Step S423) and the process ends.

If F=0 (No from Step S422), the determining unit 32 determines that the CCW address is a 24-bit real address (Step S424) and the process ends.

If V=1 (virtual address) in Step S421 (No from Step S421), the determining unit 32 determines whether or not AX=1 (Step S425). If AX=1 (Yes from Step S425), the determining unit 32 determines that the CCW address is a 32-bit virtual address (ORB STD0) (Step S426) and the process ends.

If AX=0 (No from Step S425), the determining unit 32 determines whether or not F=1 (Step S427). If F=1 (Yes from Step S427), the determining unit 32 determines that the CCW address is a 31-bit virtual address (ORB STD0) (Step S428) and the process ends.

If F=0 does not hold true (No from Step S427), the determining unit 32 determines that the CCW address is a 24-bit virtual address (ORB STD0) (Step S429) and the process ends.

As set forth above, a CCW address space is determined by the settings in an ORB.

<Address Space Determination Process for Data Address>

An address space of a data address contained in a CCW is determined by setting information in an ORB and a CCW, irrespective of setting values in the PSW 241.

As exemplified in FIG. 50, the determining unit 32 determines whether or not V in an ORB=0 (Step S431). If V=0 (real address) (Yes from Step S431), the determining unit 32 determines whether or not F=1 (Step S432).

If F=1 (Yes from Step S432), the determining unit 32 determines that the data address is a 31-bit real address (Step S433) and the process ends.

If F=0 (No from Step S432), the determining unit 32 determines that the data address is a 24-bit real address (Step S434) and the process ends.

If V=1 (virtual address) in Step S431 (No from Step S431), the determining unit 32 determines whether or not AX=1 (Step S435). If AX=1 (Yes from Step S435), the determining unit 32 determines whether or not D in the CCW=0 (Step S436)

If D=0 (Yes from Step S436), the determining unit 32 determines that the data address is a 32-bit virtual address (ORB STD0) (Step S437) and the process ends.

If D=1 (No from Step S436), the determining unit 32 determines that the data address is a 32-bit virtual address (ORB STD1) (Step S438) and the process ends.

If AX=0 in Step S435 (No from Step S435), the determining unit 32 determines whether or not F in the ORB=1 (Step S439). If F=1 (Yes from Step S439), the determining unit 32 determines whether or not D in the CCW=0 (Step S440).

If D=0 (Yes from Step S440), the determining unit 32 determines that the data address is a 31-bit virtual address (ORB STD0) (Step S441) and the process ends.

If D=1 (No from Step S440), the determining unit 32 determines that the data address is a 31-bit virtual address (ORB STD1) (Step S442) and the process ends.

If F=0 in Step S439 (No from Step S439), the determining unit 32 determines that the data address is a 24-bit virtual address (ORB STD0) (Step S443) and the process ends.

As set forth above, a data address space is determined by setting values in an ORB and a CCW.

(Dynamic Address Translation (Channel DAT))

<Descriptions on Table Formats Used for Channel DAT>

A channel DAT is a dynamic address translation by the channel subsystem 13. A channel DAT is a translation mechanism for translating a virtual address to a real address, and is embodied by the translating unit 33, for example. The translating unit 33 makes searches in the segment table 25 and the page table 26 by means of a channel DAT, and translates a CCW address and a data address from virtual addresses to real addresses.

Note that, in a channel DAT, the translating unit 33 may carry out an address translation using STD0 or STD1 set in an ORB, instead of using the PSWs 241 in the CPUs 11 and the STDs (control registers) in the CRs 243. Note that a channel DAT may be similar to a DAT by the CPUs 11, except for the difference in STDs that are made references to.

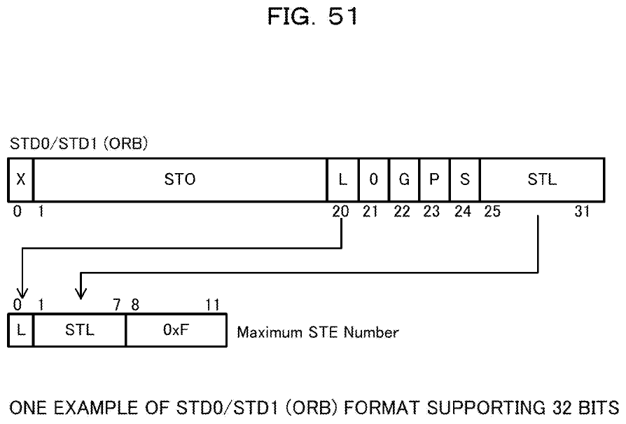

FIG. 51 is a diagram illustrating one example of the STD0/STD1 (ORB) format supporting 32 bits. As illustrated in FIG. 51, in one embodiment, an STL in STD0/STD1 included in an ORB is extended to 8 bits by employing Bit 20 (L) in the manner similar to the STD illustrated in FIG. 15. Note that STD0 and STD1 may have similar formats. Because the value of Bit 20 (L) prior to the definitions of the present disclosure is a value of 0, the conventional functions are not affected by the addition of Bit 20 (L).

The extension of an STL enables the entry count of the segment table 25 to be increased also in CCW address spaces and data address spaces, thereby allowing virtual addresses to support 32 bits.

(Exemplary Operations of Address Translation Process)

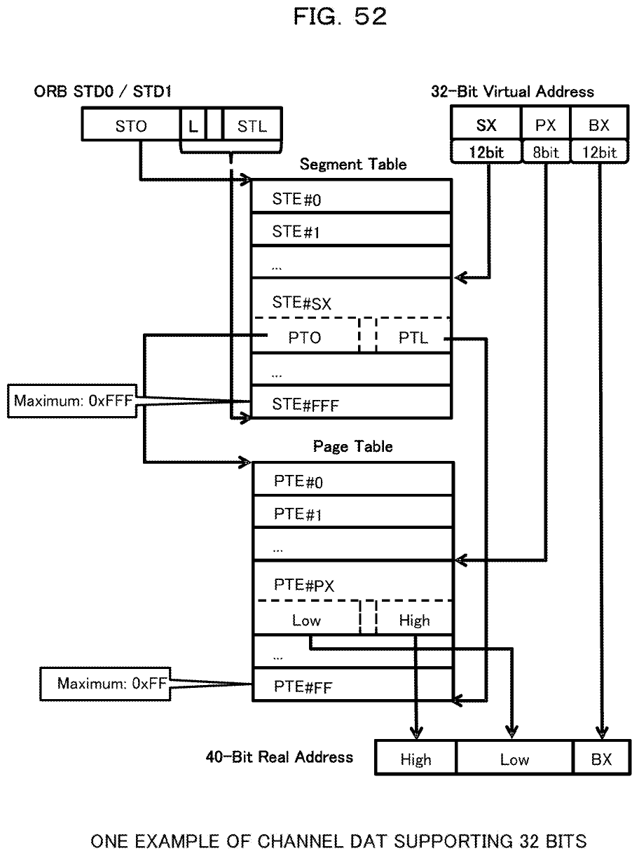

Next, referring to FIG. 52, exemplary operations of an address translation process will be described. The translating unit 33 translates a virtual address to a real address by means of a dynamic address translation (channel DAT).

As exemplified in FIG. 52, the translating unit 33 divides a 32-bit virtual address into three areas of SX, PX, and BX, identifies an STE that matches the value of the SX and a PTE that matches the value of the PX, and determines a real address using the BX.

In the search for an STE, the translating unit 33 may make a reference to the STD0 or STD1 set in an ORB, and determine the head address of the segment table 25 based on the STO in the STD0 or STD1, for example. Note that the maximum entry number in the segment table 25 is determined based on an 8-bit value defined by concatenating Bit 20 (L) and Bits 25-31 (STL) in the STD.

Furthermore, in the search for a PTE, the translating unit 33 may determine the head address of the page table 26 based on a PTO in the STE identified in the search, for example. Note that the bit width of PX is not changed and the entry count in the page table 26 is not increased from the conventional functions (supports of 24/31-bit virtual addresses).

Furthermore, in order to determine a real address, the translating unit 33 may translate a 32-bit virtual address to a 40-bit real address by concatenating High and Low, and BX in the PTE identified in the search, for example.

Note that, as described above, the support of the 32-bit virtual address function extends the bit width of virtual addresses to 32 bits, which results in an extension of the bit width of SX to 12 bits (refer to FIG. 14).

Although the extension of SX increases the entry count of the segment table 25 from 2048 entries to 4096 entries, the specification of the conventional functions does not allow the entry count exceeding 2048 because the entry count is restricted by an STL in the STD0 or STD1.

To address this, in one embodiment, an increase in the entry count of the segment table 25 is made possible by providing an STD0 and an STD1 with the new L bit, thereby mitigating the restriction on the entry count, as described above. In other words, by supplementing the calculation algorism of the maximum entry count with L bit in the STD0 and the STD1, the entry number is increased up to 4096 entries (the maximum entry number is increased to 4095 (0xFFF)).

<<1-6>> Conclusions

As set forth above, according to the computer system 1 in accordance with one embodiment, in virtual storage addressing on a host computer OS having the virtual storage mechanism, a new 32-bit mode can be added to the conventional 24-bit/31-bit modes. As a result, any changes to applications for the 24/31-bit modes are avoided, and virtual storage spaces are provided in which applications of the 32-bit mode can be operated.

With regard to the above-described technique in accordance with one embodiment, in one aspect, it can be regarded that the computer system 1 that can switch modes of virtual addresses has the following configurations or carries out the following operations, for supporting virtual storage spaces extended by the 32-bit mode:

(1) As a virtual storage address mode, the 32-bit mode is added in the form of an attribute given to each application for controlling a CPU instruction execution permission by an OS.

(2) A new mode bit (AX bit) for controlling 32-bit virtual addresses is provided to address space information controlled by the CPUs 11 and the channel subsystem 13 by means of a PSW 241 or an ORB, and the CPUs 11 carry out the following processing in a determination of an address mode:

(2-1) A determining unit 22 checks AX bit.

(2-1-A) If AX bit has a value of 1, the determining unit 22 determines as the 32-bit mode, and a processing unit 21 uses Bits 0-31 in an instruction/operand address for addressing. In this case, the processing unit 21 uses the conventional 24/31-bit address control mode bit (A bit) as the most significant Bit 0 of the address, together with Bits 0-31, for addressing.

(2-1-B) If AX bit has a value of 0, the determining unit 22 determines as the 24/31-bit mode, and maintains the compatibility with the conventional functions in the 24/31-bit mode.

(2-2) If the determining unit 22 determines as the 24/31-bit mode as a result of the check of AX bit, the determining unit 22 further checks A bit.

(2-2-A) If A bit has a value of 1, the determining unit 22 determines as the 31-bit mode and the processing unit 21 uses Bits 1-31 in the instruction/operand address for addressing.

(2-2-B) If A bit has a value of 0, the determining unit 22 determines as the 24-bit mode, the processing unit 21 uses Bits 8-31 in the instruction/operand address for addressing.

(3) When the OS gives a CPU instruction execution permission to an application, the OS (the processing unit 21) determines the attribute of the application.

(3-1) In the case of the 32-bit mode, the processing unit 21 sets a value of 1 (Enabled) to AX bit.

(3-2) In the case of the 31-bit mode, the processing unit 21 sets a value of 0 (Disabled) to AX bit and a value of 1 (Enabled) to A bit.

(3-3) In the case of the 24-bit mode, the processing unit 21 sets a value of 0 (Disabled) to AX bit and a value of 0 (Disabled) to A bit.

As described above, the support of the 32-bit virtual address mode enables the computer system 1 to extend memory areas for the OS and user applications to 4 GB. As a result, a possible deficient capacity in the 31-bit mode of about 15% (memory area of 2 GB) can be compensated for, for example.

In addition, the memory areas can be extended, while suppressing additions of a new address space. As a result, a possible occurrence of an overhead caused by switching between address spaces when a new address space is added, can be prevented.

Furthermore, by utilizing existing unused resources (bits), for example, a virtual address are as can be extended without a significant increase in resources as in cases when a 64-bit architecture is adopted.

For example, the following modifications to resources are to be made for a 64-bit architecture:
Because of extensions of bit widths of a PSW from 64 bits to 128 bit and registers from 32 bits to 64 bits, the bit width of addresses are extended from 24/31 bits to 64 bits. As a result, the maximum size of address spaces are extended from the conventional 16 MB or 2 GB to 16 EB (here, 1 EB equals 1024×1024 TB).
The size of registers is extended from the conventional 4 bytes to 8 bytes. There are two types of instructions operating registers: 4-byte dedicated instructions and 8-byte dedicated instructions.
Two types of PSWs are used: a conventional 64-bit PSW and a new 128-bit PWS. A CPU can switch between the two PSW types by executing mode switch instructions.
Control information (e.g., control registers, the prefix area, DAT tables, and the stack area) are migrated from existing areas to new areas, or their formats are significantly changed.

In accordance with the present disclosure, such additions of resources (e.g., HW) can be avoided. For example, while avoiding an addition of resources (e.g., an addition of new registers, increases in bit lengths of the registers, and addition of new instructions), it is possible to extend memory areas by means of various modifications, such as modifications to logics for HW (e.g., circuits or controllers) or modifications of bits in formats of instructions or addresses.

In addition, it is possible to continue to use programs of the conventional functions (in 24/31 bits) which need no memory extension without recompiling the program. In other words, because compatibilities to the conventional functions are ensured, any possible risks on existing program can be avoided.

For example, modifications to the formats of control information, such as a PSW 241, control registers, the prefix area, a DAT table, the stack area, are minimized. Because the information supplemented by the 32-bit virtual address function is expressed utilizing bits that are currently defined as having a value of 0 or unused, any modifications to predefined bits and existing areas are prevented.

<<2>> Miscellaneous

The aforementioned technique in accordance with one embodiment may be practiced in the following modifications and variations.

For example, the blocks provided in a CPU 11 illustrated in FIG. 2 may be combined in any combinations, or may be separate. In addition, the blocks provided in the processing unit 21 illustrated in FIG. 23 may be combined in any combinations, or may be separate. Furthermore, the blocks provided in the channel subsystem 13 illustrated in FIG. 41 may be combined in any combinations, or may be separate.

In one embodiment, particular bits that are unreserved or unused in the conventional functions in the PSW 241, an STD, an ORB, a CCW, STD0/STD1, CR0, control instructions, the stack area 28, and the like, are used for the 32-bit mode. However, the technique in accordance with one embodiment is not limited to the particular bits used in the above descriptions, and any of bits that are unreserved or unused in the conventional functions may be used for the 32-bit mode.

In addition, in one embodiment, while the technique has been described which adds the 32-bit modes in addition to the conventional functions in the 24 bit and 31-bit modes, this is not limiting and any other bit modes may be defined as the first, second, and third bit modes.

In one aspect, an efficient extension of address spaces is achieved in an information processing apparatus.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory, the processor comprising:
a first storing region comprising:
a first setting area to which a value indicating either one of a first bit mode and a second bit mode is set, the first bit mode specifying a bit length of addresses in the memory to a first bit length, the second bit mode specifying the bit length to a second bit length greater than the first bit length;
a second setting area to which information indicating whether a third bit mode is enabled or disabled is set, the third bit mode specifying the bit length to a third bit length greater than the second bit length; and
an address area to which an address in the first bit length or the second bit length is set; and
an access controller configured to, when the information set in the second setting area indicates that the third bit mode is enabled, access the memory based on a concatenated address defined by concatenating the value set in the first setting area and the address set in the address area.

2. The information processing apparatus according to claim 1, wherein
the concatenated address is a virtual address of a virtual storage area in the memory,
the processor further comprises an address translating controller configured to translate the virtual address to a real address in the memory, based on translation information indicating correspondences between virtual storage areas available in the third bit mode and real storage areas in the memory, and the concatenated address, and
the access controller is further configured to access the real address translated by the address translating controller.

3. The information processing apparatus according to claim 2, wherein
the processor further comprises a second storing region comprising a definition area to which an entry count is set, and an extension area, the entry count being a count of entries in a table used to search for the translation information, the entry count corresponding to a capacity of virtual storage areas available in the second bit mode, and
the address translating controller is further configured to, when the third bit mode is enabled, translate the virtual address to the real address based on an extended entry count defined by concatenating the entry count set in the definition area and a value set in the extension area in the second storing region, the translation information, and the concatenated address.

4. The information processing apparatus according to claim 1, wherein
the access controller is further configured to, when the information set in the second setting area indicates that the third bit mode is disabled, access the memory based on the address set in the address area, the address having a bit length corresponding to the first bit mode or the second bit mode indicated by the value set in the first setting area.

5. The information processing apparatus according to claim 1, further comprising:
a determining controller configured to determine a bit mode in which a first program associated with a first instruction to be executed by the processor, operates; and
a setting controller configured to, when the bit mode determined by the determining controller is the third bit mode, set information indicating that the third bit mode is enabled to the second setting area, and set the concatenated address to the first setting area and the address area, in the first storing region.

6. The information processing apparatus according to claim 5, wherein
the access controller is further configured to, upon switching to a second program associated with a second instruction to be executed by the processor, include information indicating whether the third bit mode is enabled or disabled, to the first instruction or a third instruction instructing the switching.

7. The information processing apparatus according to claim 1, further comprising an input-output processor coupled to the memory and an input-output apparatus, the input-output processor comprising:
an input-output access controller configured to, in response to receiving an input-output instruction from the processor:
determine a bit mode based on control information included in the input-output instruction, the control information including a third setting area to which information indicating whether the third bit mode is enabled or disabled is set, an extension area, and an input-output address area to which an address in the first bit length or the second bit length is set; and
when the bit mode is determined as the third bit mode, access the memory based on a concatenated address defined by concatenating a value in the extension area in the control information, and the address set in the input-output address area.

8. A non-transitory computer-readable recording medium having an information processing program stored thereon, for causing a computer comprising a memory, and a processor coupled to the memory, to execute a process comprising:
determine a bit mode in which a first program associated with a first instruction to be executed by the processor, operates;
when the determined bit mode is a third bit mode of a first bit mode, a second bit mode, and the third bit mode, the first bit mode specifying a bit length of addresses in the memory to a first bit length, the second bit mode specifying the bit length to a second bit length greater than the first bit length, the third bit mode specifying the bit length to a third bit length greater than the second bit length, set information indicating that the third bit mode is enabled, to a second setting area in a storing region, the storing region comprising a first setting area to which a value indicating either one of the first bit mode and the second bit mode is set, the second setting area to which the information indicating whether the third bit mode is enabled or disabled is set, and an address area to which an address in the first bit length or the second bit length is set;
set a concatenated address to the first setting area and the address area; and
access the memory based on the concatenated address defined by concatenating the value set in the first setting area and the address set in the address area.

9. The non-transitory computer-readable recording medium having the information processing program stored thereon according to claim 8, wherein the process comprises:
upon switching to a second program associated with a second instruction to be executed by the processor, include information indicating whether the third bit mode is enabled or disabled, to the first instruction or a third instruction instructing the switching.

10. A method of processing information in an information processing apparatus comprising a memory, and a processor coupled to the memory, the method comprising, by the processor:
determining, whether or not information set in a second setting area in a first storing region indicates that a third bit mode is enabled, the first storing region comprising:
a first setting area to which a value indicating either one of a first bit mode and a second bit mode is set, the first bit mode specifying a bit length of addresses in the memory to a first bit length, the second bit mode specifying the bit length to a second bit length greater than the first bit length;
the second setting area to which the information indicating whether the third bit mode is enabled or disabled is set, the third bit mode specifying the bit length to a third bit length greater than the second bit length; and
an address area to which an address in the first bit length or the second bit length is set; and
when the information set in the second setting area indicates that the third bit mode is enabled, accessing the memory based on a concatenated address defined by concatenating the value set in the first setting area and the address set in the address area.

11. The method of processing information according to claim 10, wherein
the concatenated address is a virtual address of a virtual storage area in the memory,
the method further comprises, by the processor, translating the virtual address to a real address in the memory, based on translation information indicating correspondences between virtual storage areas available in the third bit mode and real storage areas in the memory, and the concatenated address, and
the accessing comprises accessing the translated real address.

12. The method of processing information according to claim 11, wherein
the translating comprises, when the third bit mode is enabled, translating the virtual address to the real address, based on an extended entry count defined by concatenating an entry count set in a definition area and a value set in an extension area in a second storing region, the translation information, and the concatenated address, the entry count being a count of entries in a table used to search for the translation information, the entry count corresponding to a capacity of virtual storage areas available in the second bit mode, the second storing region comprising the definition area to which the entry count is set, and the extension area.

13. The method of processing information according to claim 10, wherein
the accessing comprising accessing, when the information set in the second setting area indicates that the third bit mode is disabled, the memory based on the address set in the address area, the address having a bit length corresponding to the first bit mode or the second bit mode indicated by the value set in the first setting area.

14. The method of processing information according to claim 10, further comprising, by the processor:
determining a bit mode in which a first program associated with a first instruction to be executed by the processor, operates;
setting, when the determined bit mode is the third bit mode, information indicating that the third bit mode is enabled, to the second setting area, in the first storing region; and
setting the concatenated address to the first setting area and the address area.

15. The method of processing information according to claim 14, wherein
the accessing comprises, upon switching to a second program associated with a second instruction to be executed by the processor, including information indicating whether the third bit mode is enabled or disabled, to the first instruction or a third instruction instructing the switching.

16. The method of processing information according to claim 10, wherein
the information processing apparatus comprises an input-output processor coupled to the memory and an input-output apparatus, and
the method comprises, by the input-output processor:
in response to receiving an input-output instruction from the processor, determining a bit mode based on control information included in the input-output instruction, the control information including a third setting area to which information indicating whether the third bit mode is enabled or disabled is set, an extension area, and an input-output address area to which an address in the first bit length or the second bit length is set; and
when determining as the third bit mode, accessing the memory based on a concatenated address defined by concatenating a value in the extension area in the control information and the address set in the input-output address area.
